(19) United States
(12) Patent Application Publication
(10) Pub. No.: US 2023/0152529 A1
(43) Pub. Date: May 18, 2023

(54) DETACHABLE CONNECTORS FOR HIGH FIBER COUNT APPLICATIONS

(71) Applicant: CORNING RESEARCH & DEVELOPMENT CORPORATION, Corning, NY (US)

(72) Inventors: Davide Domenico Fortusini, Ithaca, NY (US); Casey Roy Stein, Surprise, AZ (US)

(21) Appl. No.: 17/979,212

(22) Filed: Nov. 2, 2022

Related U.S. Application Data
(60) Provisional application No. 63/279,389, filed on Nov. 15, 2021.

(51) Int. Cl. G02B 6/38

(52) U.S. Cl. CPC G02B 6/3825; G02B 6/3821; G02B 6/387; G02B 6/3849; G02B 6/38875

(57) ABSTRACT

The present disclosure relates to a matched pair detachable connector for high fiber count applications where the configuration of the connector maintains optical fiber alignment and ferrule alignment during assembly of the connector.

### PRIORITY APPLICATION

This application claims the benefit of priority of U.S. Provisional Application No. 63/279,389, filed on Nov. 15, 2021, the content of which is relied upon and incorporated herein by reference in its entirety.

### FIELD OF THE DISCLOSURE

This disclosure relates generally to optical fiber cable assemblies and systems, and more particularly, to high fiber count cable assemblies and systems and the corresponding manufacturing methods thereof.

### BACKGROUND OF THE DISCLOSURE

Optical fibers are useful in a wide variety of applications, including the telecommunications industry for voice, video, and data transmissions. In a telecommunications system that uses optical fibers, there are typically many locations where fiber optic cables that carry the optical fibers connect to equipment or other fiber optic cables. To conveniently provide these connections, fiber optic connectors are often provided on the ends of fiber optic cables. The process of terminating individual optical fibers from a fiber optic cable is referred to as “connectorization.” Connectorization can be done in a factory, resulting in a “pre-connectorized” or “pre-terminated” fiber optic cable, or the field (e.g., using a “field-installable” fiber optic connector).

The rapid growth of hyperscale datacenters and 5G access networks have been driving the evolution of optical fiber cables toward increasing fiber count and density. Deployment of outside plant cables within datacenters has been a capital intensive infrastructure investment, and datacenter operators typically pre-install ducts to connect campus wide buildings. The ducts have various diameters ranging from 1 inch to 4 inches.

In conventional cable deployment, the cables are first installed through the ducts or micro-ducts. The cables are subsequently terminated in the field through fusion splicing inside a transition splice cabinet or a splice closure. Splicing in the field is a costly and time consuming process involving skilled field technicians. Field splicing also requires workspace that is sometimes unavailable.

Pre-terminated cables installed through the ducts are challenging since the connectors need to be packaged in a pulling grip that conforms to the cable diameter. The lack of high fiber count connectors coupled with the increase of fiber density exacerbates the problem. For example, a 6,912 fiber cable requires as many as 288 connectors if each connector terminates 24 fibers. An ideal connectivity between the furcated outside plant cable and the indoor cable would have a single or a small number of connections that only require a few matings over the lifetime. Commercially available highest fiber count single mode connectors are limited to 32 fibers. Moreover, the cost per fiber termination increases when moving to higher fiber count connectors due to the reduced yield in both connector and the assembly process.

With existing connector termination technology plateauing at about 32 fiber per connector, there is a need for alternative high fiber count termination process that enable the connections of more than 144 fibers in a small footprint, while providing at least the same level of insertion loss and cost per fiber termination.

### SUMMARY OF THE DISCLOSURE

The present disclosure relates to a matched pair detachable connector for high fiber count applications where the configuration of the connector maintains optical fiber alignment and ferrule alignment during assembly of the connector.

In one embodiment, an optical fiber connector assembly is provided. The optical fiber connector assembly comprising: a plurality of optical fibers; a connector including: a ferrule having an inner channel in which the plurality of optical fibers are secured, the ferrule having at least one groove on an outer surface of the ferrule and along a length of the ferrule; at least one stabilizing body received in the at least one groove; and a sleeve applied onto the ferrule; wherein the sleeve defines or engages the at least one stabilizing body and creates an interference fit between the ferrule and the sleeve.

In another embodiment, the sleeve includes at least one protrusion integrally formed with the sleeve to define the at least one stabilizing body In another embodiment, the sleeve spans a circumference of the ferrule. In another embodiment, a portion of the outer surface of the ferrule is in contact with the sleeve. In another embodiment, the ferrule includes at least one protrusion along the outer surface of the ferrule that engages with the sleeve. In another embodiment, the at least one stabilizing body comprises at least one pin received in the at least one groove, wherein the sleeve and engages the at least one pin and creates the interference fit. In another embodiment, the sleeve spans the outer surface of the ferrule. In another embodiment, a portion of the outer surface of the ferrule is in contact with the sleeve. In another embodiment, the ferrule includes at least one protrusion along the outer surface of the ferrule that engages with the sleeve. In another embodiment, the sleeve includes a slit extending along a length of the sleeve to create a gap, wherein the gap is aligned with at least a portion of the inner channel of the ferrule. In another embodiment, the sleeve includes a helical slit along a length of the sleeve.

In one embodiment, an optical fiber connector assembly is provided. The optical fiber connector assembly comprising: a plurality of optical fibers; a connector including: a ferrule having an inner channel in which the plurality of optical fibers are secured, the ferrule having at least one groove on an outer surface of the ferrule and along a length of the ferrule; at least one stabilizing body received in the at least one groove; and a sleeve applied onto the ferrule, wherein the sleeve defines or engages the at least one stabilizing body and creates an interference fit between the ferrule and the sleeve; a compression sleeve received over at least a portion of the sleeve, wherein the compression sleeve includes a plurality of teeth that contact the sleeve; a center barrel having an inner channel that houses the connector, wherein the center barrel includes an inward protrusion that defines at least one slanted surface within the inner channel; and a connector nut secured to the center barrel and urging compression sleeve against the at one slanted surface so that the plurality of teeth of the compression sleeve apply a radial force onto the connector.

In another embodiment, the inward protrusion of center barrel contacts the connector. In another embodiment, the optical fiber connector assembly further comprising a spring retained within the connector nut and configured to bias the ferrule relative to the connector nut. In another embodiment, the optical fiber connector assembly further comprising a bushing between ferrule and spring, wherein biasing force from the spring is transferred to the ferrule by the bushing. In another embodiment, the spring is received on a spring sleeve that contacts the bushing to transfer the biasing force to the bushing. In another embodiment, the sleeve includes at least one protrusion integrally formed with the sleeve to define the at least one stabilizing body. In another embodiment, the sleeve spans a circumference of the ferrule. In another embodiment, a portion of the outer surface of the ferrule is in contact with the sleeve. In another embodiment, the ferrule includes at least one protrusion along the outer surface of the ferrule that engages with the sleeve. In another embodiment, the at least one stabilizing body comprises at least one pin received in the at least one groove, wherein the sleeve engages the at least one pin and creates the interference fit. In another embodiment, the sleeve spans the outer surface of the ferrule. In another embodiment, a portion of the outer surface of the ferrule is in contact with the sleeve. In another embodiment, the ferrule includes at least one protrusion along the outer surface of the ferrule that engages with the sleeve. In another embodiment, the sleeve includes a slit extending along a length of the sleeve to create a gap, wherein the gap is aligned with the inner channel of the ferrule. In another embodiment, the sleeve includes a helical slit along a length of the sleeve.

In one embodiment, a method of assembling a connector assembly is provided. The method of assembling a connector assembly comprising: inserting a plurality of optical fibers into an inner channel of a ferrule; installing a bushing onto either side of the ferrule; inserting an adhesive into the inner channel; dicing the ferrule along a dicing plane to form a first connector ferrule and a second connector ferrule, wherein the dicing plane has an angle θ relative to a longitudinal axis of the ferrule; applying a sleeve onto the first connector ferrule to form a first connector; inserting the first connector into an inner channel of a center barrel, wherein at least the sleeve extends beyond an opening of the center barrel; inserting the second connector ferrule into the sleeve to form a connector; and moving the first connector ferrule, the second connector ferrule, and the sleeve into the inner channel.

In another embodiment, the method further comprising: securing a connector nut to the center barrel; applying a compression sleeve onto the sleeve and adjacent to the connector nut; wherein the connector nut urges the compression sleeve against an inward protrusion of the center barrel. In another embodiment, the inward protrusion of the center barrel contacts the connector. In another embodiment, the method further comprising retaining a spring within the connector nut, wherein the spring is configured to bias the ferrule relative to the connector nut. In another embodiment, the spring is received on a spring sleeve that contacts the bushing to transfer the biasing force to the bushing. In another embodiment, the angle θ ranges between 82° and 90°.

Additional features will be set forth in the detailed description which follows, and in part will be readily apparent to those skilled in the technical field of optical communications. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the description serve to explain principles and operation of the various embodiments. Persons skilled in the technical field of optical connectivity will appreciate how features and attributes associated with embodiments shown in one of the drawings may be applied to embodiments shown in others of the drawings.

FIG. 1 is a side perspective view of a cable assembly in accordance with the present disclosure;

FIG. 2 is a cross-sectional view of an outdoor cable shown in the cable assembly of FIG. 1;

FIG. 3 is a perspective view of a connector assembly in accordance with the present disclosure;

FIG. 4 is an exploded view of the connector assembly of FIG. 3;

FIG. 4A is a cross-sectional view of a center barrel of the connector assembly of FIG. 3;

FIG. 5 is a cross-sectional view of the connector assembly of FIG. 3;

FIG. 6 is a perspective view of a ferrule of the connector assembly of FIG. 3;

FIG. 7 is a front view of the ferrule of FIG. 6;

FIG. 8 is a cross sectional view of an embodiment of a connector of the connector assembly of FIG. 3;

FIG. 8A is a perspective view of the connector of FIG. 8;

FIG. 9 is a cross sectional view of an alternate embodiment of a connector of the connector assembly of FIG. 3;

FIG. 9A is a perspective view of the connector of FIG. 9;

FIGS. 10-15 are cross sectional views of alternate embodiments of a connector of the connector assembly of FIG. 3;

FIG. 16 is a perspective view of an alternate sleeve that can be used for connectors and connector assemblies in accordance with the present disclosure;

FIG. 17 is an exploded, perspective view of a bushing of the connector of the connector assembly of FIG. 3; and

FIG. 18-34 are illustrations depicting a method of assembling a connector and a connector assembly in accordance with the present disclosure.

### DETAILED DESCRIPTION

Various embodiments will be further clarified by examples in the description below. In general, the present disclosure relates to a matched pair detachable connector for high fiber count applications where the configuration of the connector maintains optical fiber alignment and ferrule alignment during assembly of the connector.

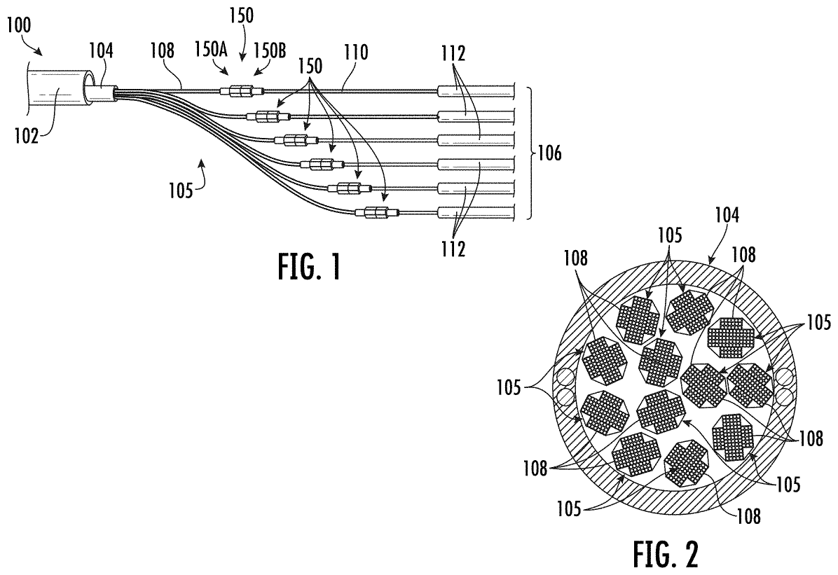

Referring first to FIG. 1, a cable assembly 100 is shown. Cable assembly 100 includes an outdoor cable 104 (e.g., a high fiber count cable) and an indoor cable 106 (e.g., a lower fiber count cable with a flame retardant jacket) that mate together as discussed herein. Outdoor cable 104 is fed through a duct 102 of a building (e.g., hyperscale datacenter, etc.) and includes multiple subunits 105. Subunits 105 comprise optical fibers 108 or optical fiber ribbons 108. Optical fibers 108 of outdoor cable 104 are configured to connect to optical fibers 110 of indoor cable 106 by a connector assembly 150 as discussed in greater detail herein. In some embodiments, the connection between optical fibers 108 and optical fibers 110 can comprise greater than 144 optical fibers, which are housed in connector assembly 150. Outdoor cable 104 is scalable to accommodate high optical fiber counts such as 6,912 optical fibers depending on the optical fiber diameters. In other embodiments, connector assembly 150 can be used with only indoor cables 106 or only outdoor cables 104.

Optical fibers 108, 110 may comprise different fiber types, different coating diameters, different ribbon formats, or a different combination of the above. In some embodiments, fiber types include standard single mode fibers or highly bend insensitive fibers. The fiber coating diameters include 250 μm, 200 μm, 180 μm, 160 μm and lower fiber coating diameters. The ribbon formats include fully encapsulated ribbon and rollable ribbon. Such combinations offer flexibility that can be tailored to different applications as opposed to the prior art where all the fiber attributes must be identical on both sides of the connection.

Referring briefly to FIG. 2, a cross-sectional view of an embodiment of outdoor cable 104 is shown in accordance with aspects of the present disclosure. As shown, outdoor cable 104 has 12 routable subunits 105; however, it is contemplated that in alternate embodiments, alternate number of subunits 105 may be included in outdoor cable 104. Each of the subunits 105 includes optical fibers 108 loosely disposed within the subunit 105 (e.g., in an essentially parallel array). In certain embodiments, the optical fibers 108 may be coated with a thin film of powder (e.g., chalk, talc, etc.) which forms a separation layer that prevents the fibers from sticking to the molten sheath material during extrusion.

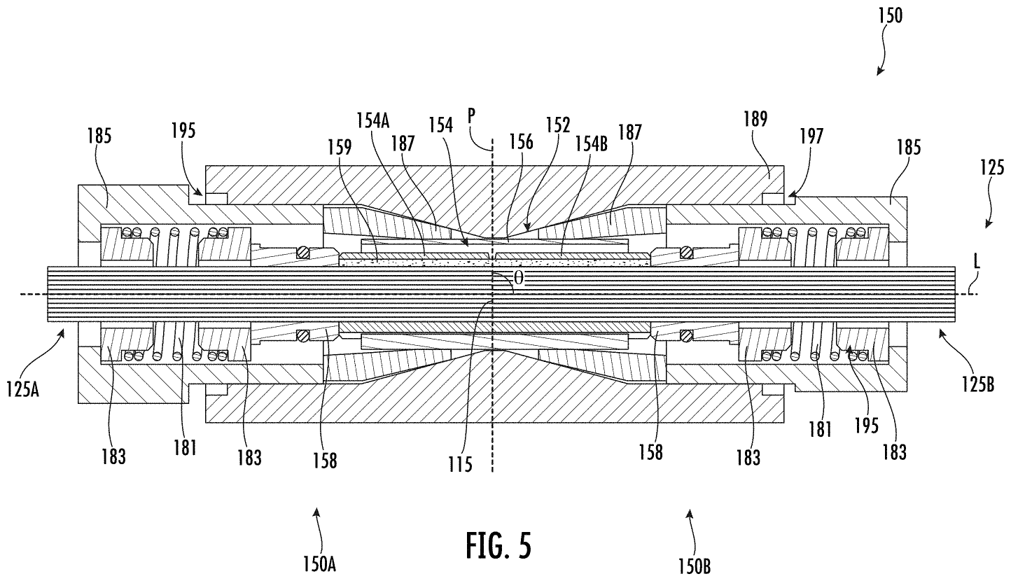

Referring back to FIG. 1, indoor cables 106 are generally housed within an interior of a building (e.g., hyperscale datacenter, etc.) and comprise an outer jacket 112 from which optical fibers 110 protrude. Each indoor cable 106 requires a smaller number of matched connections with outdoor cable 104. For example, a 288 fiber indoor cable 106 and a 288 fiber subunit 105 from outdoor cable 104 requires two 144 fiber matched connectors 150A, 150B (FIG. 5). As shown in FIG. 1, connector assemblies 150 are staggered so that cable assembly 100 can be enclosed in a pulling grip with a size close to the outer diameter of outside cable 104 for installation through duct 102.

While the above disclosure describes the use of connector assembly 150 with outdoor cable 104 and indoor cable 106, connector assembly 150 of the present disclosure can be used in alternate settings such as where connector assembly 150 is used with only indoor cables or optical fibers 125, for example, as discussed herein.

As used herein, “optical fibers” refer to either embodiment of singular, loose optical fibers or ribbonized optical fibers or stacked ribbonized optical fibers. Moreover, the present disclosure discusses dicing a connector 152 and optical fibers 150. In particular, when connector 152 is diced, connector 152 is diced into connectors 150A, 150B as discussed in greater detail herein. Similarly, when optical fibers 125 are diced, optical fibers 125 are diced into diced optical fibers 125A, 125B as discussed in greater detail herein.

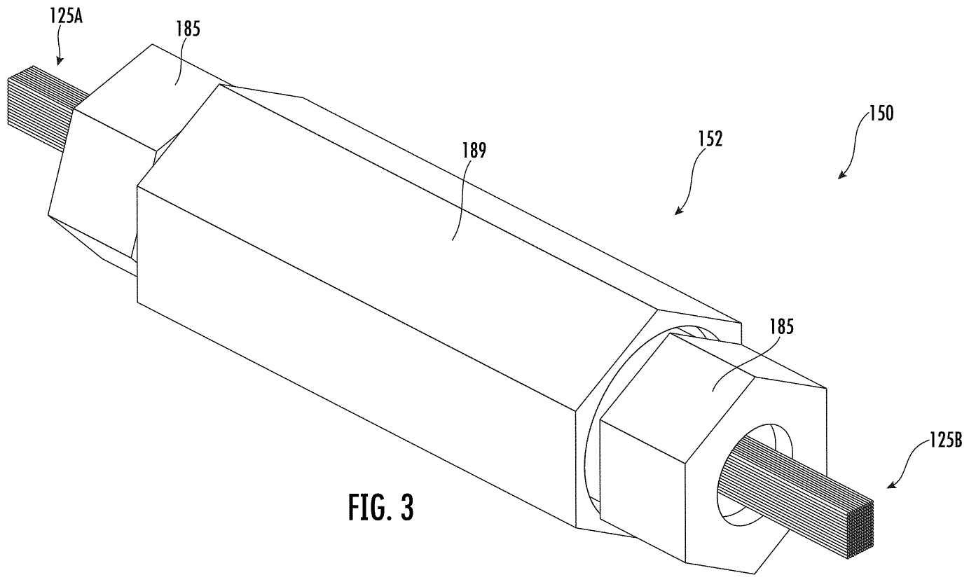

Referring now to FIGS. 3-5, optical fibers 125 are placed in a connector assembly 150. Connector assembly 150 comprises a connector 152, spring 181, spring sleeve 183, connector nut 185, compression sleeve 187, and center barrel 189. Connector 152 comprises a connector housing or ferrule 154, a sleeve 156, and a bushing 158. It is within the scope of the present disclosure that in alternate embodiments, connector 152 comprises a ferrule 154 and a sleeve 156, and connector assembly comprises bushing 158, spring 181, spring sleeve 183, connector nut 185, compression sleeve 187, and center barrel 189.

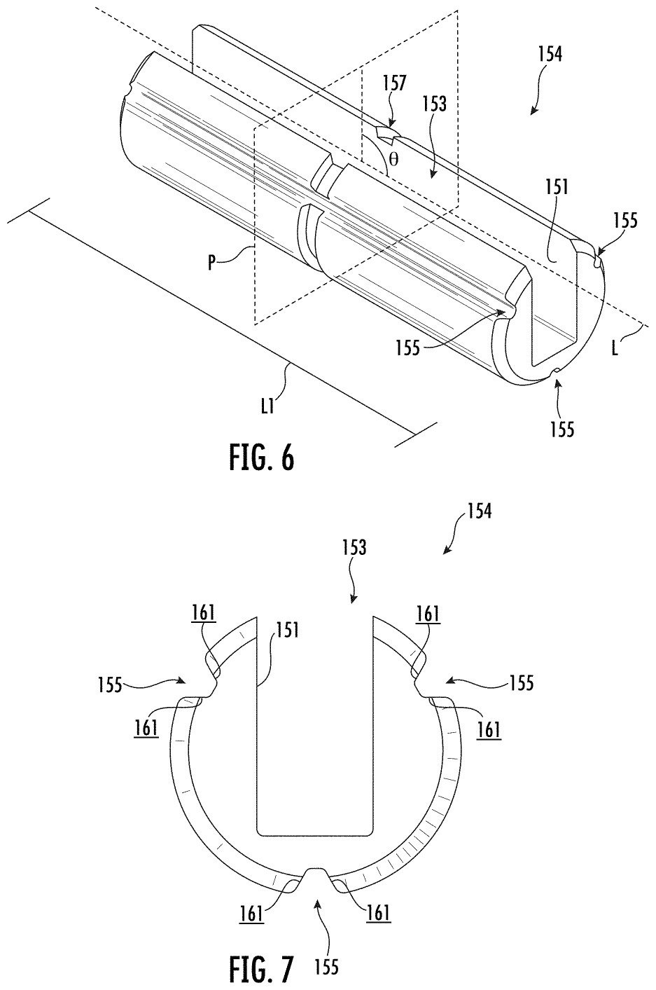

Referring now to FIGS. 6 and 7, ferrule 154 includes comprises at least one wall 151 to define an inner channel 153 along a longitudinal axis L of ferrule 154. In some embodiments, ferrule 154 is generally U-shaped. However, it is within the scope of the present disclosure that alternate shapes of ferrule 154 may be used. For example, ferrule 154 may include additional channels to house a greater number of optical fibers (e.g., more than 144 optical fibers such as 288 fiber or 432 fiber matched connector pairs). It is also within the scope of the present disclosure that in alternate embodiments, ferrule 154 may be modified to house fewer optical fibers (e.g., less than 144 optical fibers). Inner channel 153 is configured to house optical fibers 125 (shown in at least FIG. 5), and in some embodiments, optical fibers 125 are substantially parallel to longitudinal axis L of ferrule 154. As used herein, “substantially parallel” refers to parallel axes to within 0.15° relative to each other. Inner channel 153 houses mating interface 115 of diced optical fibers 125A, 125B.

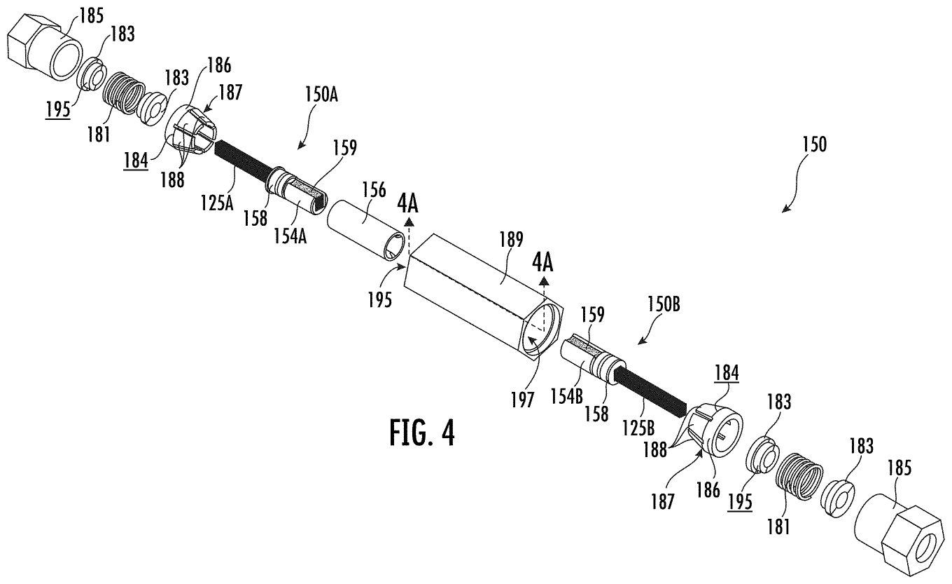

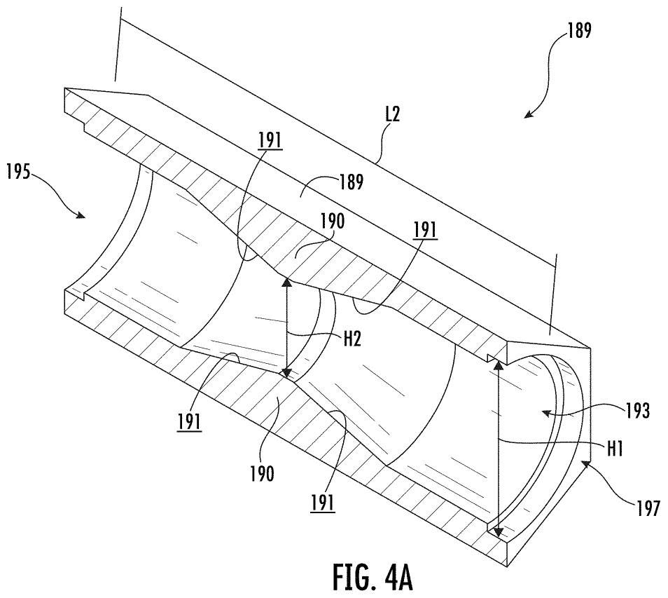

As shown in at least FIGS. 4 and 5, inner channel 153 also receives a potting adhesive 159 configured to fill in the spaces between optical fibers 125 and to hold diced optical fibers 125A, 125B of optical fibers 125 in place to maintain alignment between connectors 150A, 150B and thereby, yielding improved insertion loss properties as discussed herein. To hold or encapsulate potting adhesive 159 within ferrule 154, a sleeve 156 and a bushing 158 (shown in at least FIGS. 4 and 5) are applied onto ferrule 154 as discussed in greater detail below. In some embodiments, cured potting adhesive 169 has a modulus of elasticity ranging between 0.1 GPa and 10 GPa, between 1 GPa and 5 GPa, or between 1 GPa and 3 GPa. As used herein, “cured potting adhesive” refers to when potting adhesive 169 reaches full bonding strength. In some embodiments, potting adhesive 159 has a shrinkage ratio (volume reduction after curing) ranging between 0.1% and 5%, between 0.5% and 3%, or between 0.5% and 2%. In some embodiments, potting adhesive 159 has a coefficient of thermal expansion ranging between 10×10⁻⁶/° C. and 200×10⁻⁶/° C., between 20×10⁻⁶/° C. and 150×10⁻⁶/° C., or between 20×10⁻⁶/° C. and 100×10⁻⁶/° C.

Referring now to FIGS. 6 and 7, ferrule 154 also includes a plurality of grooves 155 that extend along a length L1 and generally parallel to longitudinal axis L of ferrule 154. As discussed in greater detail below, grooves 155 are configured to provide an area for a stabilizing body such as pins 160 or protrusions 175 (both of which are discussed in greater detail below) to be seated onto ferrule 154 when assembling connector 152. As shown, in this embodiment, grooves 155 are equally spaced from each other about the circumference of ferrule 154. Stated another way, grooves 155 are spaced about 120 degrees from each other. In some embodiments, grooves 155 are spaced at an angle ranging between 110 degrees and 130 degrees from each other. However, in alternate embodiments, the number and spacing of grooves 155 around the circumference of ferrule 154 may be varied as discussed below. In addition, in this embodiment, grooves 155 are V-grooves in which edges 161 of grooves 155 are substantially straight and uniform along length L1 of ferrule 154. In alternate embodiments, grooves 155 may have an alternate shape where edges 161 are not straight as discussed herein.

Ferrule 154 further comprises a dicing groove or center groove 157. Dicing groove 157 identifies approximately where ferrule 154 is to be diced to form connectors 150A, 150B. That is, dicing groove 157 defines a dicing plane P (that is co-planar with dicing groove 157) through which ferrule 154 and housed optical fibers 125 are diced as discussed in greater detail below. In some embodiments, dicing plane P is perpendicular to longitudinal axis L. In some embodiments, dicing plane P is angled with respect to longitudinal axis L to enhance return loss performance of connector assembly 150. In some embodiments, dicing plane P has an angle θ ranging between 1° and 8°, between 2° and 7°, or between 3° and 6° off 90° with respect to longitudinal axis L. Stated another way, angle θ ranges between 82° and 89°, 830 and 88°, or 84° and 87° with respect to longitudinal axis L. In some embodiments, dicing plane P has an angle θ of about 8° off 90° with respect to longitudinal axis L. Stated another way, in some embodiments, angle θ is about 82° with respect to longitudinal axis L. In some embodiments, when dicing plane P is angled, the splice joints 115 of optical fibers 125 are staggered in accordance with the angle of dicing plane P relative to longitudinal axis L.

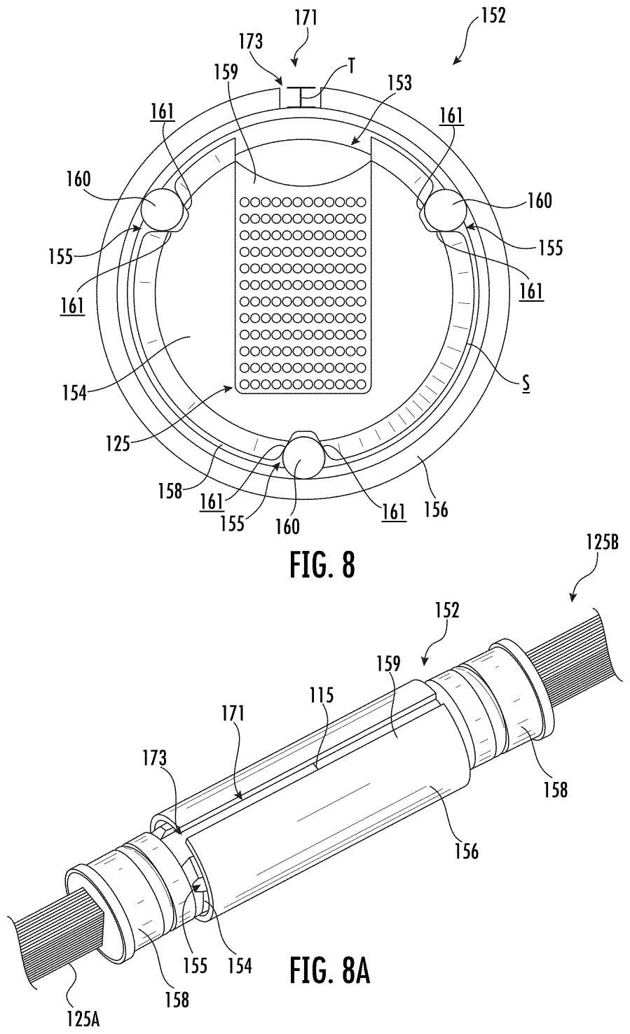

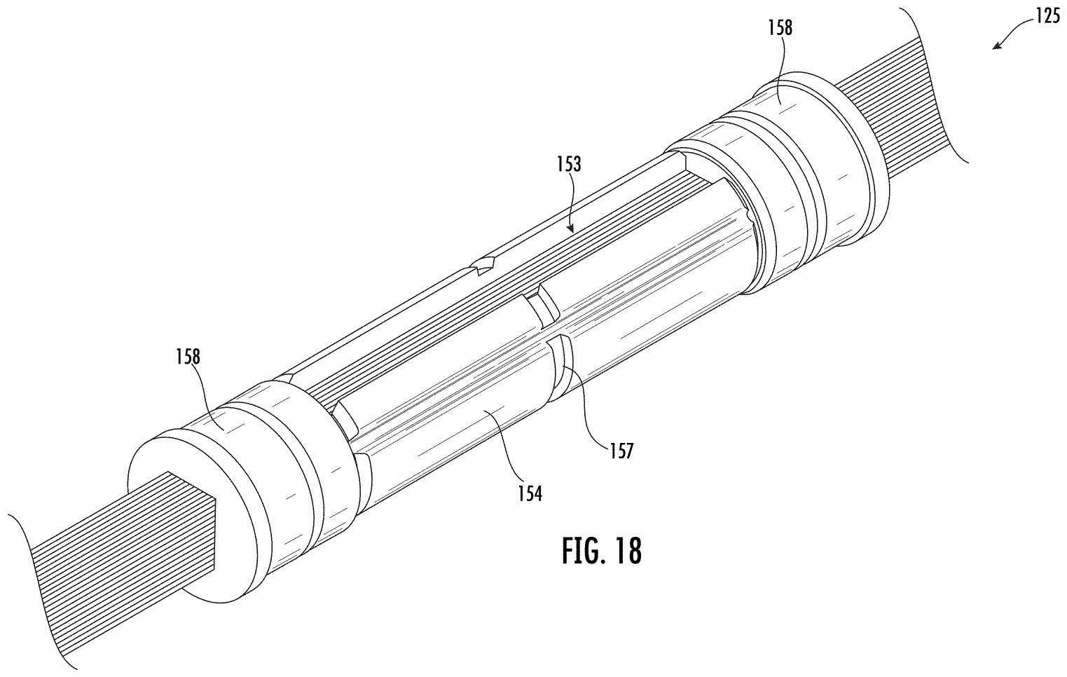

As mentioned previously, connector 152 further comprises a sleeve 156 and a bushing 158. Sleeve 156 is applied onto the circumference of ferrule 154. Sleeve 156 spans the circumference or outer surface S of ferrule 154. Sleeve 156 is configured to define or engage at least one stabilizing body (e.g., pins 160 or protrusions 175 as discussed in greater detail below) against an outer surface S of ferrule 154 and in particular, into grooves 155 of ferrule 154. Various embodiments of ferrule 154, sleeve 156, and pins 160 are shown in FIGS. 8-16 and discussed in greater detail below. In some embodiments, sleeve 156 has a length such that sleeve 156 covers the circumference of ferrule 154. In some embodiments, sleeve 156 includes a slit 171 that extends linearly along length L3 and through length L3 of sleeve 156 to provide a gap 173 in covering the circumference of ferrule 154. Stated another way, gap 173 of sleeve 156 is aligned with at least a portion of inner channel 153 of ferrule 154. However, in alternate embodiments, slit 171 is helical along length L3 of sleeve 156 as shown in FIG. 16. Advantageously, a helical slit 171 provides installation flexibility as helical slit 171 and corresponding gap 173 can be oriented in more positions along the circumference of ferrule 154 without disturbing the alignment of ferrule 154 of mated connectors 150A, 150B within sleeve 156. Also, helical slit 171 clamps or provides a compressive force that is normal to and uniformly distributed about the circumference of ferrule 154, which can enhance the structural integrity of the connector 152 and connector assembly 150. In some embodiments, sleeve 156 has a uniform thickness T. However, in alternate embodiments, sleeve 156 has a non-uniform thickness where sleeve 156 includes protrusions 175 that are integrally formed with sleeve 156 to define the stabilizing body to be received into grooves 155.

FIGS. 8-15 as discussed below show various embodiments of connector 152 and the corresponding configurations of ferrule 154, sleeve 156, and pins 160.

Referring first to FIG. 8, an embodiment of connector 152, and the configuration of ferrule 154, sleeve 156, and pins 160 is shown. As shown, ferrule 154 includes three (3) grooves 155 that are equally spaced apart from each other about the circumference of ferrule 154 (i.e., grooves 155 are spaced about 120 degrees apart from each other). Moreover, grooves 155 are V-shaped grooves in which edges 161 are substantially straight and uniform along length L1 of ferrule 154. As shown, pins 160 are seated within grooves 155 and are held in place against edges 161 by sleeve 156. Sleeve 156 engages pins 160 such that sleeve 156 and ferrule 154 are in an interference fit. Sleeve 156, when engaged with pins 160, maintains the position of pins 160 along length L1 of ferrule 154 of mated connectors 150A, 150B and thereby, maintains rotational alignment and radial alignment of optical fibers 125A, 125B and alignment of inner channel 153 of mated connectors 150A, 150B as shown in FIG. 8A. Sleeve 156 has a uniform thickness T and includes a slit 171 to define a gap 173 along a length of sleeve 156.

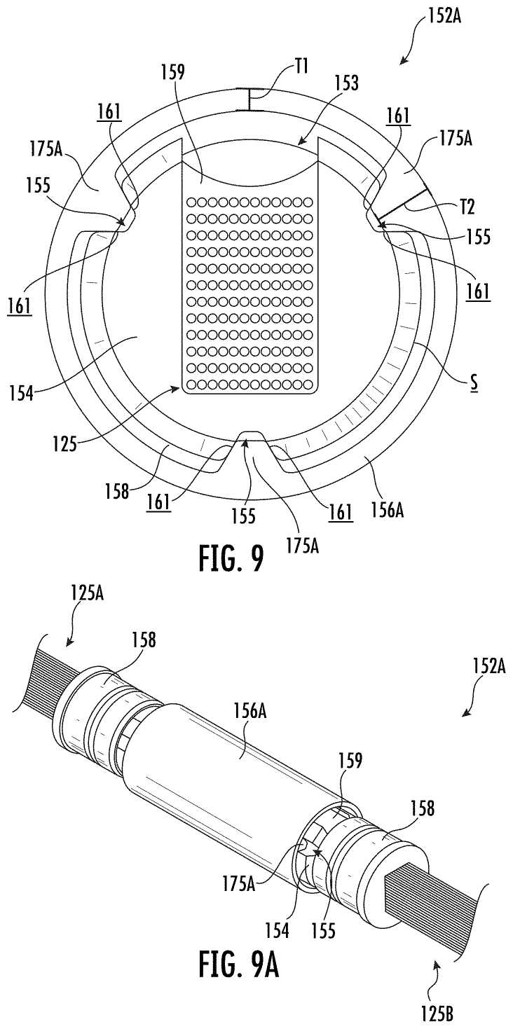

Referring now to FIG. 9, an alternate embodiment of connector 152 (referred to as “connector 152A”) and the configuration of ferrule 154, sleeve 156, and pins 160 are shown. In this embodiment, the components that are consistent with those disclosed in reference to FIG. 8 will have the same reference numbers with those differing having the letter “A” placed along the same reference number. Similar to connector 152 of FIG. 8, ferrule 154 includes three (3) grooves 155 that are equally spaced apart from each other about the circumference of ferrule 154 (i.e., grooves 155 are spaced about 120 degrees apart from each other). Moreover, grooves 155 are V-shaped grooves in which edges 161 are substantially straight and uniform along length L1 of ferrule 154. As shown, connector 152A does not include any pins 160, and rather, connector 152A includes a sleeve 156A that has a variable thickness. In particular, sleeve 156A includes a plurality of spines or protrusions 175A having a thickness T2 that is different from thickness T1 of sleeve 156A, and protrusions 175A are inserted into grooves 155 to create an interference fit between sleeve 156A and ferrule 154. In this configuration, protrusions 175A extend throughout length L1 of ferrule 154 and maintain alignment of optical fibers 125A, 125B of connectors 150A, 150B and alignment of inner channel 153 of connectors 150A, 150B. In particular, protrusions 175A maintain rotational alignment and radial alignment of ferrule 154 of mated connectors 150A, 150B. Also, sleeve 156A does not include a slit 171 and therefore, does not include a gap 173 along a length of sleeve 156. Advantageously, the interference fit between sleeve 156A and ferrule 154 provides additional compressive forces onto grooves 155 thereby maintaining alignment of ferrule 154 and optical fibers 108, 110 of mated connectors 150A, 150B as shown in FIG. 9A. As used herein, “rotational alignment” refers to alignment of components in a direction about a longitudinal axis L of optical fibers 125 where longitudinal axis L is the axis of rotation. As also used herein, “radial alignment” refers to alignment of components in a direction outwardly from a longitudinal axis L where longitudinal axis L is a center from which the radial alignment extends.

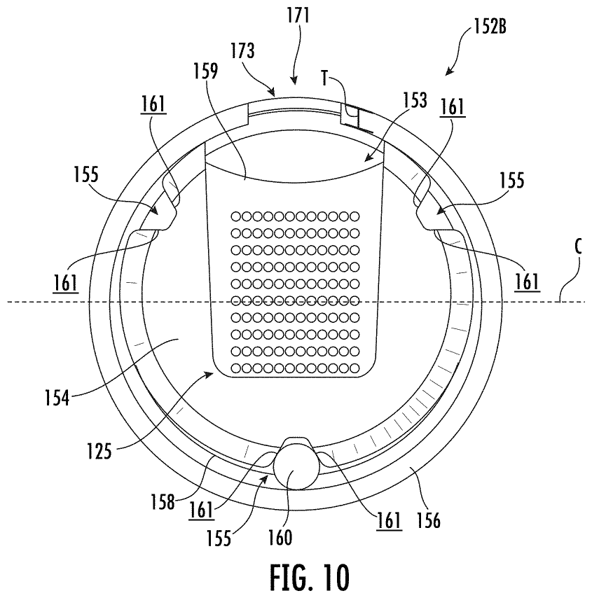

Referring now to FIG. 10, an alternate embodiment of connector 152 (referred to as “connector 152B”) and the configuration of ferrule 154, sleeve 156, and pins 160 are shown. As mentioned previously, in this embodiment, the components that are consistent with those disclosed in reference to FIG. 8 will have the same reference numbers with those differing having the letter “B” placed along the same reference number. Ferrule 154 includes three (3) grooves 155 that are unequally spaced apart from each other about the circumference of ferrule 154. That is, as shown, grooves 155 that are closer to the opening of ferrule 154 are closer to each other than the groove 155 below inner channel 153. Grooves 155 are V-shaped grooves in which edges 161 are substantially straight and uniform along length L1 of ferrule 154. As shown, connector 152B includes a single pin 160 received in one of grooves 155 while the other grooves 155 do not have a pin 160. Pin 160 is held within groove 155 by sleeve 156 (substantially the same as sleeve 156 of FIG. 8 described above) as shown. Sleeve 156 engages pin 160 such that sleeve 156 and ferrule 154 are in an interference fit. In addition, sleeve 156 engages with a portion of an outer surface S of ferrule 154. In particular, sleeve 156 engages with a portion of an upper half of ferrule 154 where the upper half is the portion of ferrule 154 above centerline C as shown in FIG. 10. Sleeve 156 has a uniform thickness T and includes a slit 171 to define a gap 173 along a length of sleeve 156. In this configuration, pin 160 extends throughout length L1 of ferrule 154 and maintains alignment of optical fibers 125A, 125B of connectors 150A, 150B and alignment of inner channel 153 of connectors 150A, 150B. In particular, pin 160 maintains rotational alignment of ferrule 154 of mated connectors 150A, 150B, and sleeve 156 maintains radial alignment of mated connectors 150A, 150B. Another advantage of this configuration is that there are a fewer number of components with only one pin 160. As such, maintenance of connector assembly 150 is improved.

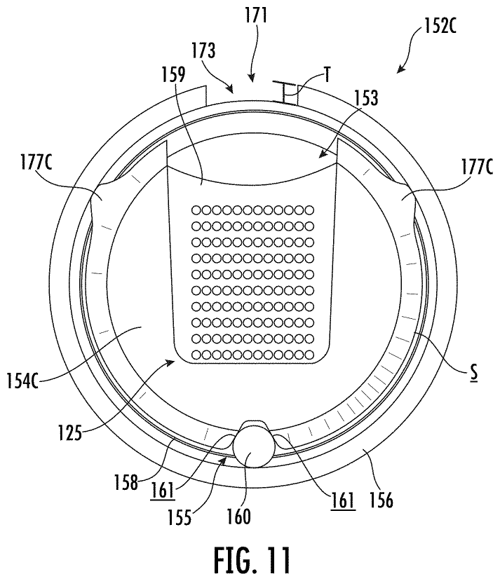

Referring now to FIG. 11, an alternate embodiment of connector 152 (referred to as “connector 152C”) and the configuration of ferrule 154, sleeve 156, and pins 160 are shown. As mentioned previously, in this embodiment, the components that are consistent with those disclosed in reference to FIG. 8 will have the same reference numbers with those differing having the letter “C” placed along the same reference number. Ferrule 154C includes one (1) groove 155 and two (2) protrusions 177C that are unequally spaced apart from each other about the circumference of ferrule 154C. That is, as shown, protrusions 177C are closer to the opening of ferrule 154C and are closer to each other than the groove 155 below inner channel 153. Protrusions 177C are V-shaped in this embodiment where protrusions 177C have straight edges that are uniform along length L1 of ferrule 154C; however, it is within the scope of the present disclosure that in alternate embodiments, other suitable shapes of protrusions 177C may be used. In this embodiment, groove 155 is a V-shaped groove in which edges 161 are substantially straight and uniform along length L1 of ferrule 154C. As shown, connector 152C includes a single pin 160 received in groove 155. Pin 160 is held within groove 155 by sleeve 156 (substantially the same as sleeve 156 of FIG. 8 described above) as shown. In particular, sleeve 156 engages pin 160 such that sleeve 156 and ferrule 154 are in an interference fit. Sleeve 156 also engages with protrusions 177C. Advantageously, in this configuration, the force of sleeve 156 is applied more evenly about the circumference of ferrule 154. Sleeve 156 has a uniform thickness T and includes a slit 171 to define a gap 173 along a length of sleeve 156. Similar to the configuration of FIG. 10, pin 160 extends throughout length L1 of ferrule 154 and maintains alignment of optical fibers 125A, 125B of connectors 150A, 150B and alignment of inner channel 153 of connectors 150A, 150B. In particular, pin 160 maintains rotational alignment of ferrule 154C of mated connectors 150A, 150B, and sleeve 156 maintains radial alignment of mated connectors 150A, 150B. Another advantage of this configuration is that there are a fewer number of components with only one pin 160. As such, maintenance of connector assembly 150 is improved.

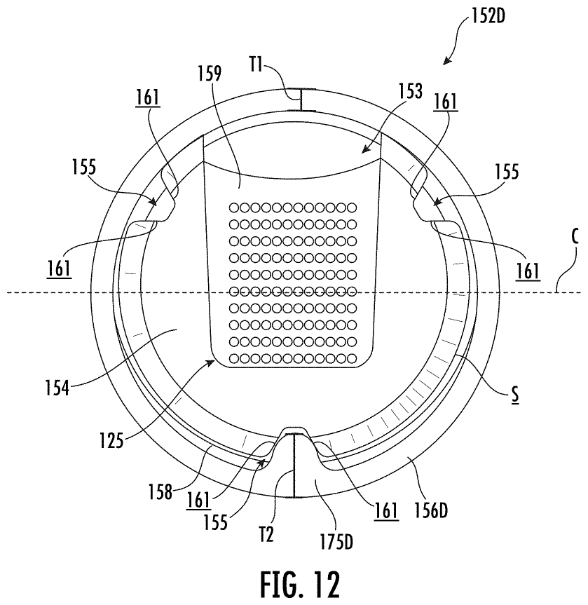

Referring now to FIG. 12, an alternate embodiment of connector 152 (referred to as “connector 152D”) and the configuration of ferrule 154, sleeve 156, and pins 160 are shown. In this embodiment, the components that are consistent with those disclosed in reference to FIG. 8 will have the same reference numbers with those differing having the letter “D” placed along the same reference number. Similar to connector 152B of FIG. 10, ferrule 154 includes three (3) grooves 155 that are unequally spaced apart from each other about the circumference of ferrule 154. That is, as shown, grooves 155 that are closer to the opening of ferule 154 are closer to each other than the groove 155 below inner channel 153. Grooves 155 are V-shaped grooves in which edges 161 are substantially straight and uniform along length L1 of ferrule 154. As shown, connector 152D does not include any pins 160, and rather, connector 152D includes a sleeve 156D that has a variable thickness. In particular, sleeve 156D includes a spine or protrusion 175D having a thickness T2 that is different from thickness T1 of sleeve 156D, and protrusion 175D is inserted into groove 155 below inner channel 153 to create an interference fit between sleeve 156D and ferrule 154. In this configuration, protrusion 175AD extends throughout length L1 of ferrule 154 and maintains alignment of optical fibers 125A, 125B of connectors 150A, 150B and alignment of inner channel 153 of connectors 150A, 150B. In particular, protrusion 175D maintains rotational alignment of ferrule 154 of mated connectors 150A, 150B, and sleeve 156 maintains radial alignment of mated connectors 150A, 150B. Also, sleeve 156D does not include a slit 171 and therefore, does not include a gap 173 along a length of sleeve 156D. Advantageously, the interference fit between sleeve 156D and ferrule 154 provides additional compressive forces onto grooves 155 thereby maintaining alignment of ferrule 154 and optical fibers 108, 110 of mated connectors 150A, 150B as shown in FIG. 9A. In addition, sleeve 156D engages with a portion of an outer surface S of ferrule 154. In particular, sleeve 156D engages with a portion of an upper half of ferrule 154 where the upper half is the portion of ferrule 154 above centerline C as shown in FIG. 12.

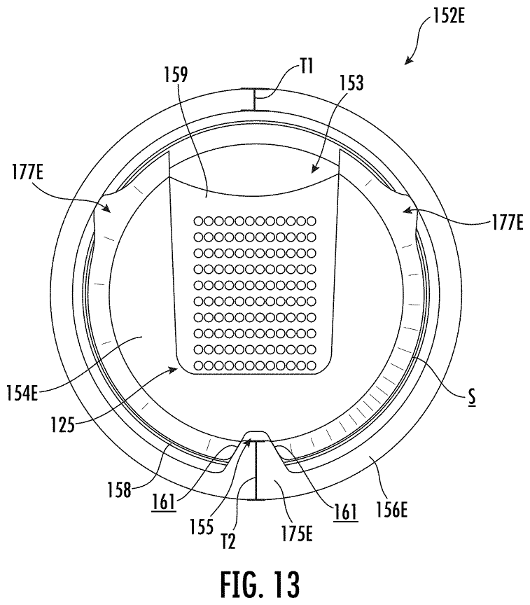

Referring now to FIG. 13, an alternate embodiment of connector 152 (referred to as “connector 152E”) and the configuration of ferrule 154E, sleeve 156, and pins 160 are shown. As mentioned previously, in this embodiment, the components that are consistent with those disclosed in reference to FIG. 8 will have the same reference numbers with those differing having the letter “E” placed along the same reference number. Ferrule 154E includes one (1) grooves 155 and two (2) protrusions 177E that are unequally spaced apart from each other about the circumference of ferrule 154E. That is, as shown, protrusions 177E are closer to the opening of ferrule 154E and are closer to each other than the groove 155 below inner channel 153. Protrusions 177E are V-shaped in this embodiment where protrusions 177E have straight edges that are uniform along length L1 of ferrule 154E; however, it is within the scope of the present disclosure that in alternate embodiments, other suitable shapes of protrusions 177E may be used. In this embodiment, groove 155 is a V-shaped groove in which edges 161 are substantially straight and uniform along length L1 of ferrule 154E. As shown, connector 152E does not include any pins 160, and rather, connector 152E includes a sleeve 156E that has a variable thickness. In particular, sleeve 156E includes a spine or protrusion 175E having a thickness T2 that is different from thickness T1 of sleeve 156E, and protrusion 175E is inserted into groove 155 below inner channel 153 to create an interference fit between sleeve 156E and ferrule 154E. In this configuration, protrusion 175E extends throughout length L1 of ferrule 154 and maintains alignment of optical fibers 125A, 125B of connectors 150A, 150B and alignment of inner channel 153 of connectors 150A, 150B. In particular, protrusion 175E maintains rotational alignment of ferrule 154 of mated connectors 150A, 150B, and sleeve 156 maintains radial alignment of mated connectors 150A, 150B. Also, sleeve 156E does not include a slit 171 and therefore, does not include a gap 173 along a length of sleeve 156E. Advantageously, the interference fit between sleeve 156E and ferrule 154E provides additional compressive forces onto grooves 155 thereby maintaining alignment of ferrule 154E of mated connectors 150A, 150B. Sleeve 156E also engages with protrusions 177E. Advantageously, in this configuration, the force of sleeve 156E is applied more evenly about the circumference of ferrule 154. Another advantage of this configuration is that there are a fewer number of components with only sleeve 156E. As such, maintenance of connector assembly 150 is improved.

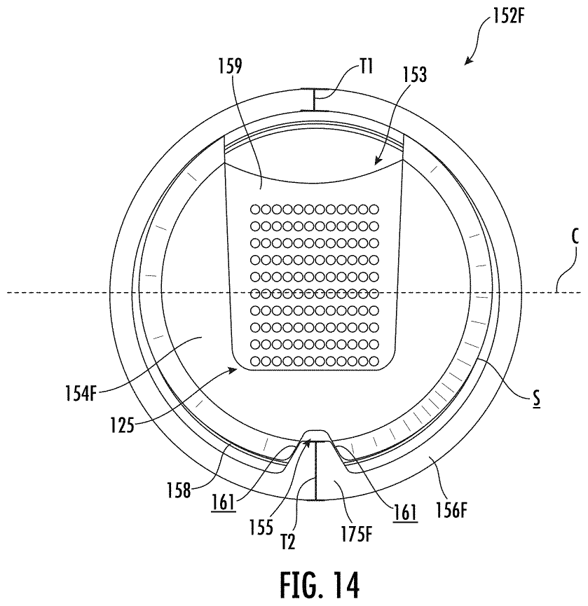

Referring now to FIG. 14, an alternate embodiment of connector 152 (referred to as “connector 152F”) and the configuration of ferrule 154, sleeve 156, and pins 160 are shown. In this embodiment, the components that are consistent with those disclosed in reference to FIG. 8 will have the same reference numbers with those differing having the letter “F” placed along the same reference number. Ferrule 154 includes one (1) groove 155 that is V-shaped and is defined by edges 161 in which edges 161 are substantially straight and uniform along length L1 of ferrule 154. As shown, connector 152F does not include any pins 160, and rather, connector 152F includes a sleeve 156F that has a variable thickness. In particular, sleeve 156F includes a spines or protrusions 175F having a thickness T2 that is different from thickness T1 of sleeve 156F, and protrusion 175F is inserted into groove 155 below inner channel 153 to create an interference fit between sleeve 156D and ferrule 154. In this configuration, protrusions 175F extends throughout length L1 of ferrule 154 and maintains alignment of optical fibers 125A, 125B of connectors 150A, 150B and alignment of inner channel 153 of connectors 150A, 150B. In particular, protrusion 175F maintains rotational alignment of ferrule 154 of mated connectors 150A, 150B, and sleeve 156 maintains radial alignment of mated connectors 150A, 150B. Also, sleeve 156F does not include a slit 171 and therefore, does not include a gap 173 along a length of sleeve 156F. Advantageously, the interference fit between sleeve 156F and ferrule 154 provides additional compressive forces onto grooves 155 thereby maintaining alignment of ferrule 154 and diced optical fibers 125A, 125B of optical fibers 125 of mated connectors 150A, 150B. In addition, sleeve 156F engages with a portion of an outer surface S of ferrule 154. In particular, sleeve 156F engages with a portion of an upper half of ferrule 154 where the upper half is the portion of ferrule 154 above centerline C as shown in FIG. 12.

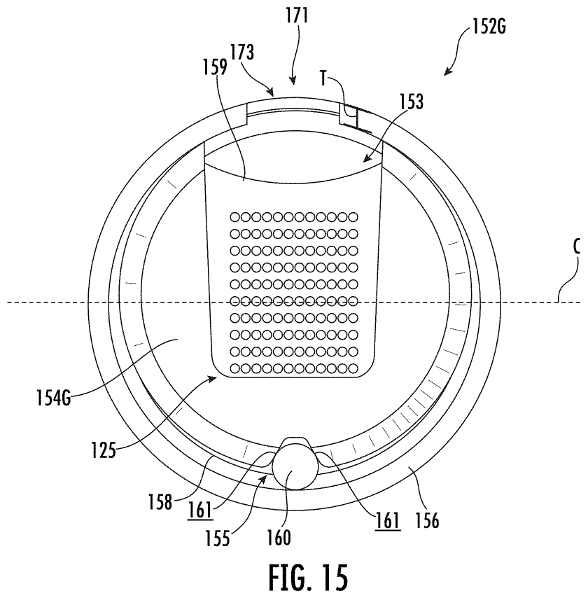

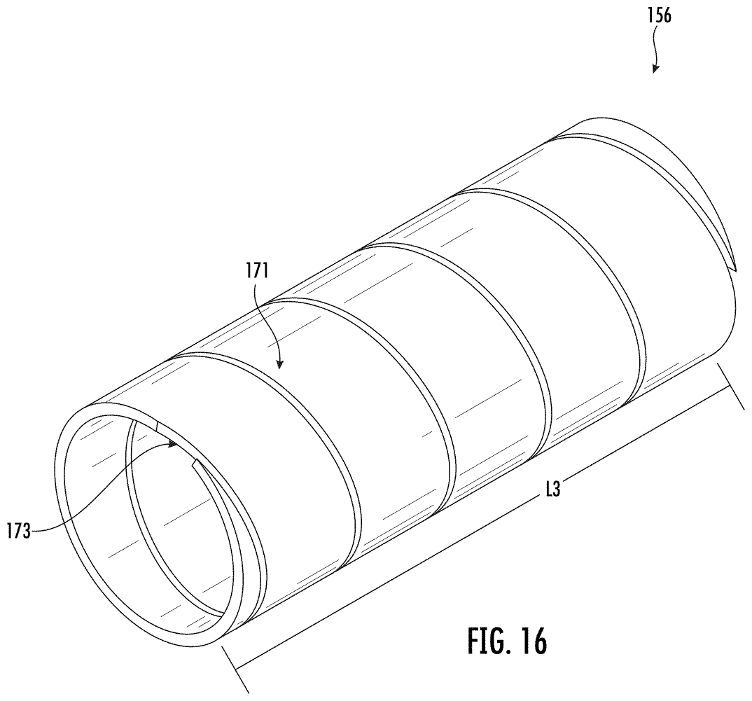

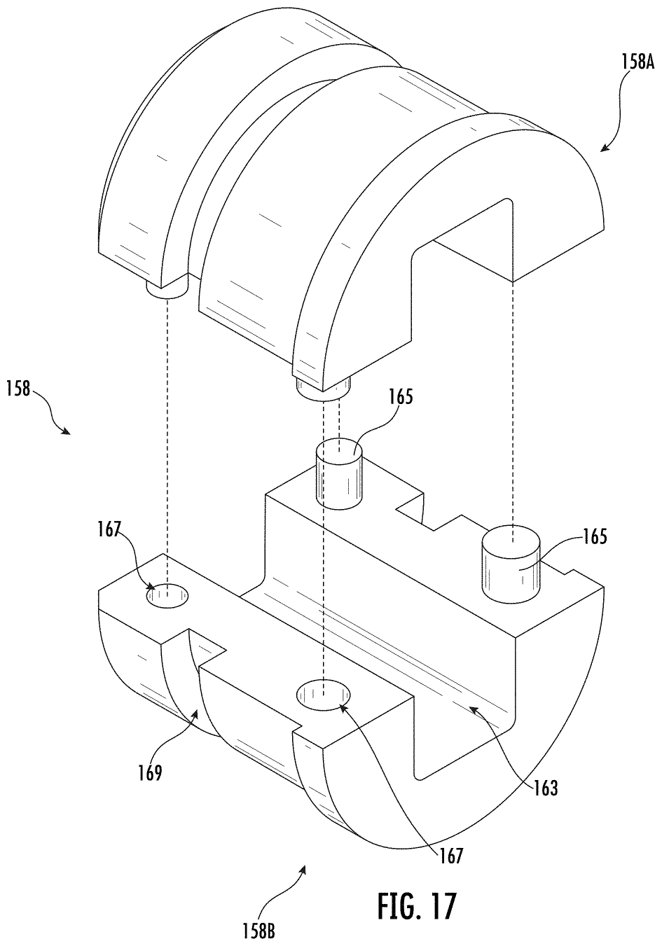

Referring now to FIG. 15, an alternate embodiment of connector 152 (referred to as “connector 152G”) and the configuration of ferrule 154, sleeve 156, and pins 160 are shown. As mentioned previously, in this embodiment, the components that are consistent with those disclosed in reference to FIG. 8 will have the same reference numbers with those differing having the letter “B” placed along the same reference number. Ferrule 154G includes one (1) groove 155 that is V-shaped and is defined by edges 161 in which edges 161 are substantially straight and uniform along length L1 of ferrule 154. As shown, connector 152G includes a single pin 160 received in groove 155. Pin 160 is held within groove 155 by sleeve 156 (substantially the same as sleeve 156 of FIG. 8 described above) as shown. Sleeve 156 engages pin 160 such that sleeve 156 and ferrule 154 are in an interference fit. In addition, sleeve 156 engages with a portion of an outer surface S of ferrule 154. In particular, sleeve 156 engages with a portion of an upper half of ferrule 154 where the upper half is the portion of ferrule 154 above centerline C as shown in FIG. 10. Sleeve 156 has a uniform thickness T and includes a slit 171 to define a gap 173 along a length of sleeve 156. In this configuration, pin 160 extends throughout length L1 of ferrule 154 and maintains alignment of optical fibers 125A, 125B of connectors 150A, 150B and alignment of inner channel 153 of connectors 150A, 150B. In particular, pin 160 maintains rotational alignment of ferrule 154 of mated connectors 150A, 150B, and sleeve 156 maintains radial alignment of mated connectors 150A, 150B. Another advantage of this configuration is that there are a fewer number of components with only one pin 160. As such, maintenance of connector assembly 150 is improved.

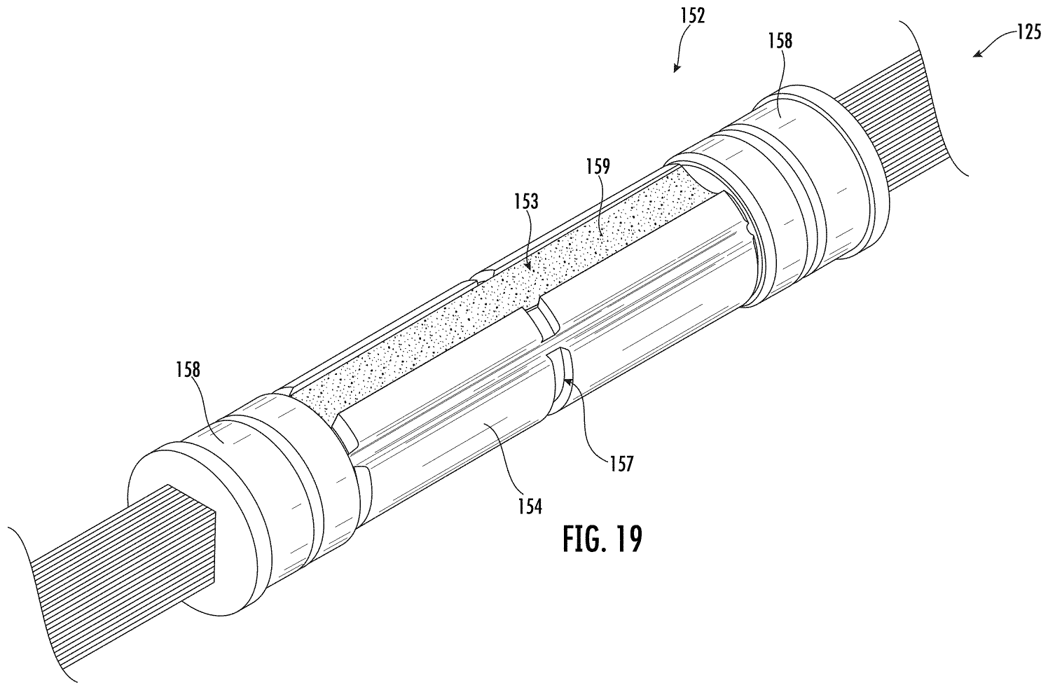

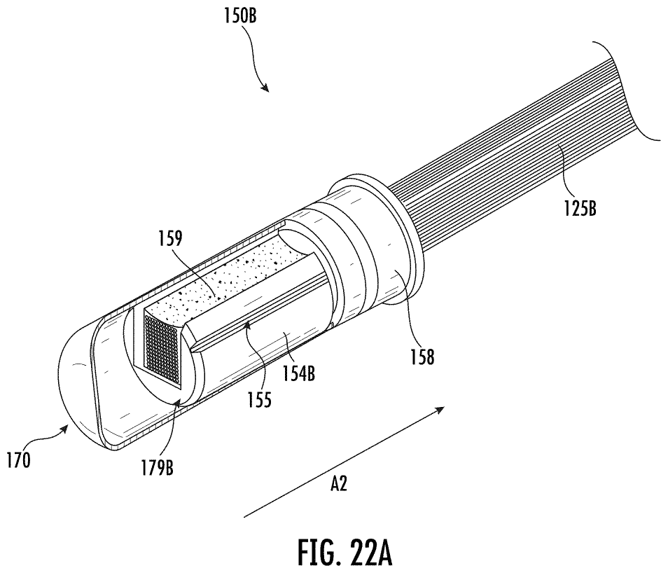

Referring now to FIG. 17, a bushing 158 of connector 152 is shown. As mentioned previously, bushing 158 is configured to hold potting adhesive 159 within ferrule 154. In addition, bushing 158 is configured to receive biasing forces (in an axial direction) applied by spring 181 (as discussed below) and transfer the biasing forces onto ferrule 154. Bushing 158 comprises two halves 158A, 158B that define a passageway 163 through which optical fibers or optical fiber ribbons 108 pass through. As shown, half 158A includes a pair of protrusions 165 and a pair of apertures 167, and half 158B includes a pair of protrusions 165 and a pair of apertures 167. Protrusions 165 of half 158A are configured to be inserted into apertures 167 of half 158B (and vice versa) to couple halves 158A, 158B to each other and form bushing 158. When halves 158A, 158B are coupled together, a groove 169 is defined, and groove 169 is configured to receive an O-ring of a dust cap 170 when dust cap 170 is coupled onto at least one of connectors 150A, 150B (i.e., ferrule 154 and bushing 158) to promote sealing of optical fibers 125 as shown in FIGS. 22 and 22A.

Referring back to FIGS. 3-5, as mentioned previously, connector assembly 150 includes spring 181, spring sleeve 183, connector nut 185, compression sleeve 187, and center barrel 189. Spring 181 is positioned adjacent bushing 158 and is retained in connector nut 185. Spring 181 is configured to bias ferrule 154 relative to connector nut 185. Spring 181 is also configured to apply a continuous axial force onto ferrule 154 to maintain axial alignment of mated connectors 150A, 150B. Such axial alignment is maintained through condition changes (e.g., temperature changes, etc.). As used herein, “axial alignment” refers to alignment of components along a longitudinal axis L of optical fibers 125 in a direction parallel to longitudinal axis L.

Spring sleeve 183 is installed on each end of connector assembly 150 between connector nut 185 and ferrule 154. Spring sleeve 183 is configured to provide a surface onto which spring 181 applies biasing forces (in an axial direction) that is transferred to ferrule 154 (via bushing 158) and functions to maintain axial alignment of mated connectors 150A, 150B as discussed above. Connector nut 185 is coupled to spring 181 and bushing 158. Connector nut 185 is configured to compress spring 181 as connector nut 185 is coupled to center barrel 189. Connector nut 185 also applies an axial force onto compression sleeve 187 that is converted into a radial force onto sleeve 156 to further aid in securing mated connectors 150A, 150B of connector assembly 150 as discussed below. Compression sleeve 187 is installed over ferrule 154 as discussed in greater detail below. As shown, compression sleeve 187 includes a cylindrical body 186 with a plurality of teeth 188 spaced apart from each other and are coupled to cylindrical body 186 such that teeth 188 extend from an edge 184 of cylindrical body 186. Teeth 188 are flexible and are configured to contact sleeve 156 and to provide a securing force onto sleeve 156. As discussed in greater detail, the securing force provided by compression sleeve 187 is converted from an axial force to a radial force by center barrel 189.

Center barrel 189 couples to connector nut 185 and sleeve 156 as discussed in greater detail below and is configured to provide additional securing forces onto connector assembly 150 (in particular, ferrule 154 of connector assembly 150). Referring briefly to FIG. 4A, center barrel 189 is a hexagonal structure with a cylindrical inner channel 193. It is within the scope of the present disclosure that in alternate embodiments, center barrel 189 has an alternate suitable shape. Center barrel 189 has a length L2 that is greater than length L1 of ferrule 154. As shown, center barrel 189. Center barrel 189 has an inner channel 193 extending through length L2. As shown, inner channel 193 has a variable height throughout the length of inner channel 193. In particular, inner channel 193 has a height H1 at the ends of center barrel 189 and a height H2 within center barrel 189 (i.e., near the midpoint of inner channel 193). Stated another way, center barrel 189 has inward protrusions 190 that extend into inner channel 193. Inward protrusions 190 are defined by edges 191 as shown. Inward protrusions 190 and corresponding edges 191 are configured to contact compression sleeve 187 and connector 152 and sleeve 156 to apply additional radial force onto sleeve 156 and ensure coaxial alignment of mated connectors 150A, 150B.

Referring now to FIGS. 18-33, a method of assembling connector 152 and connector assembly 150 is shown. Referring first to FIG. 18, optical fibers 125 are placed into ferrule 154 as shown. Then, bushings 158 are installed on either side of ferrule 154 and adjacent to ferrule 154 by feeding optical fibers 125 through passageway 163 when coupling halves 158A, 158B of bushing 158.

As shown in FIG. 19, potting adhesive 159 is then inserted into inner channel 153 of ferrule 154 to fill in the spaces between optical fibers 108, 110 of optical fibers 125 and to hold optical fibers 125 in place to maintain alignment of connector 152 of connector assembly 150. In some embodiments, optical fibers 125 and potting adhesive 159 are inserted into inner channel 153 of ferrule 154 in an alternating layering pattern as discussed below. That is, a first layer of potting adhesive 159 is inserted into inner channel 153, and a first layer of optical fibers 125 is inserted on top of the first layer of the potting adhesive 159. This insertion sequence is continued until a final layer of potting adhesive 159 is inserted on top of the final layer of optical fibers 125. For example, for twelve optical fiber ribbons inserted into inner channel 153, there will be thirteen total layers of potting adhesive 159 where each layer of potting adhesive 159 is interspersed between each layer of optical fiber ribbon as discussed above.

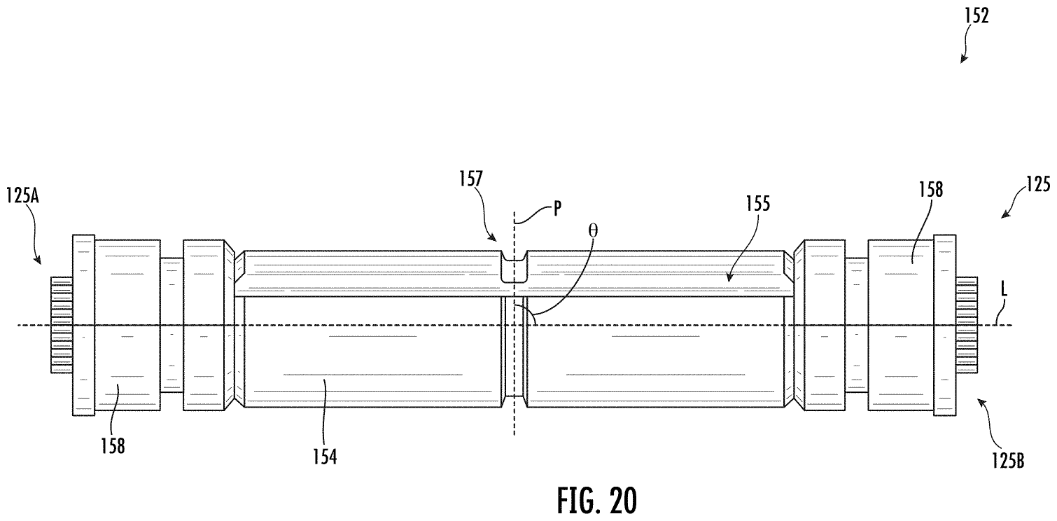

Connector 152 is then diced along dicing plane P to form connectors 150A, 150B and corresponding diced optical fibers 125A, 125B and diced connector ferrules 154A, 154B from connector assembly 150 as described above and shown in FIG. 20. In some embodiments, connector assembly 150 is diced with a cutting tool (e.g., diamond wire dicing saw, etc.) to form connectors 150A, 150B. Additional details relating to the performance of optical fibers 125 after dicing are disclosed in U.S. Patent Application No. 63/225,606, filed Jul. 26, 2021, the contents of which are incorporated by reference herein.

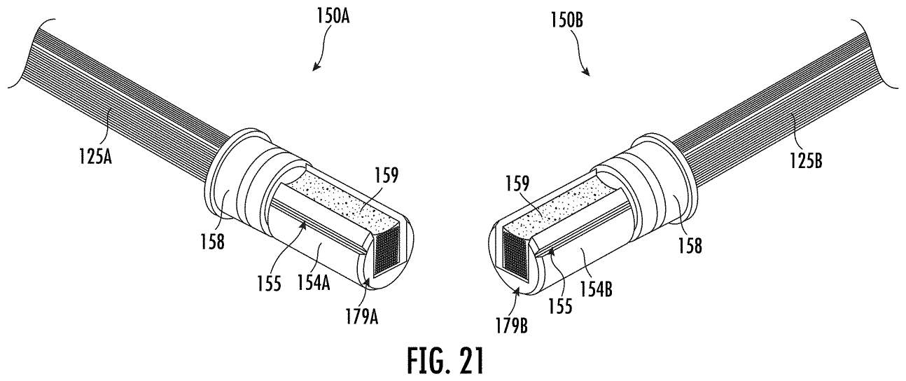

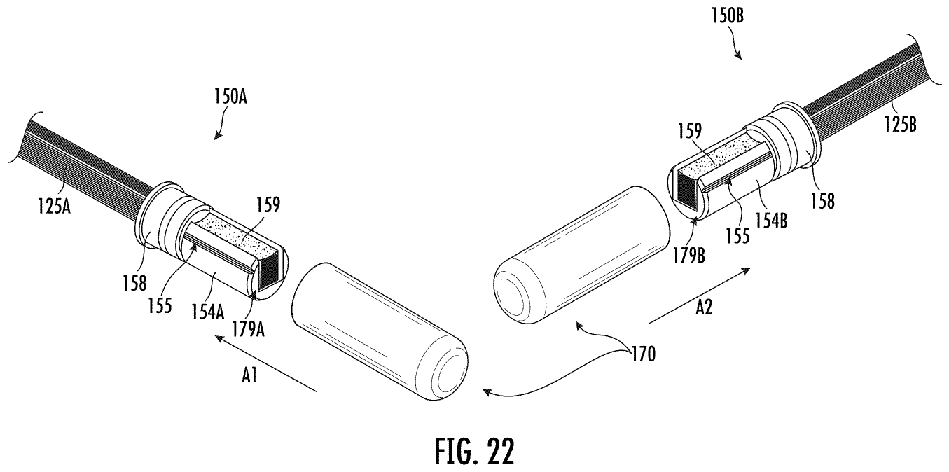

Referring now to FIG. 21, after dicing, connectors 150A, 150B have corresponding end faces 179A, 179B that may require polishing depending on the quality of the cut performed along dicing plane P. In addition, an index matching layer may be applied onto end faces 179A, 179B. Details relating to the type of index matching layer and the application of index matching layer are disclosed in U.S. Patent Application No. 63/225,606, filed Jul. 26, 2021, the contents of which are incorporated by reference herein.

After optional polishing of end faces 179A, 179B and optional application of an index matching layer onto end faces 179A, 179B, dust caps 170 are applied onto at least one of connectors 150A, 150B as shown in FIG. 22 while connectors 150A, 150B undergo further processing in the assembly of connector 150. Dust caps 170 are applied onto connectors 150A, 150B along directions A1, A2, respectively. Referring briefly to FIG. 22A, dust cap 170 (shown in partial cross section) includes an O-ring that engages with groove 169 of bushing 158 to seal optical fibers 125A, 125B. Moreover, applying dust caps 170 onto connectors 150A, 150B provides physical protection of ferrule 154 and housed optical fibers 108, 110 to prevent damage from external debris while applying other components of connector assembly 150 onto connectors 150A, 150B as discussed below. For discussion purposes, dust cap 170 is applied onto both connectors 150A, 150B. However, it is within the scope of the present disclosure that dust cap 170 can be applied onto one of connectors 150A, 150B.

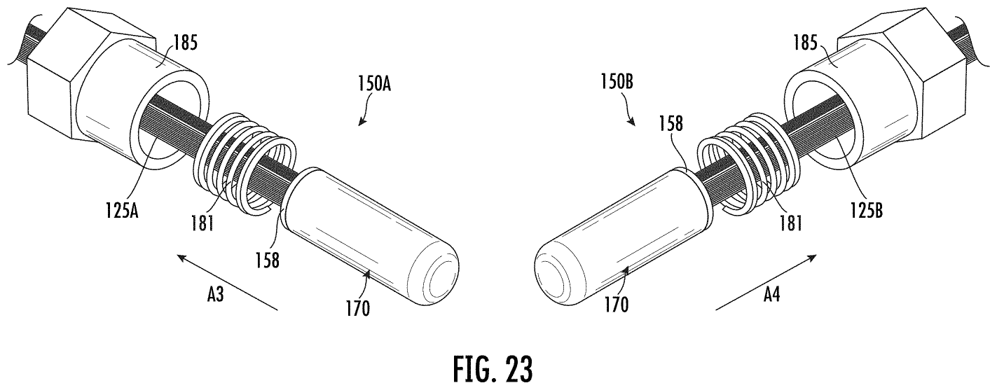

Referring now to FIG. 23, after connectors 150A, 150B are placed in dust caps 170, a connector nut 185 and a spring 181 are applied onto connectors 150A, 150B along directions A3, A4, respectively. In particular, connector nut 185 and spring 181 encircle diced optical fibers 125A, 125B by moving from in front of end faces 179A, 179B (encased in dust caps 170) along directions A3, A4 to a position adjacent to and downstream of bushing 158 as shown. As used herein, “downstream” refers to a position distal from ferrule 154 of connectors 150A, 150B and along respective diced optical fibers 125A, 125B.

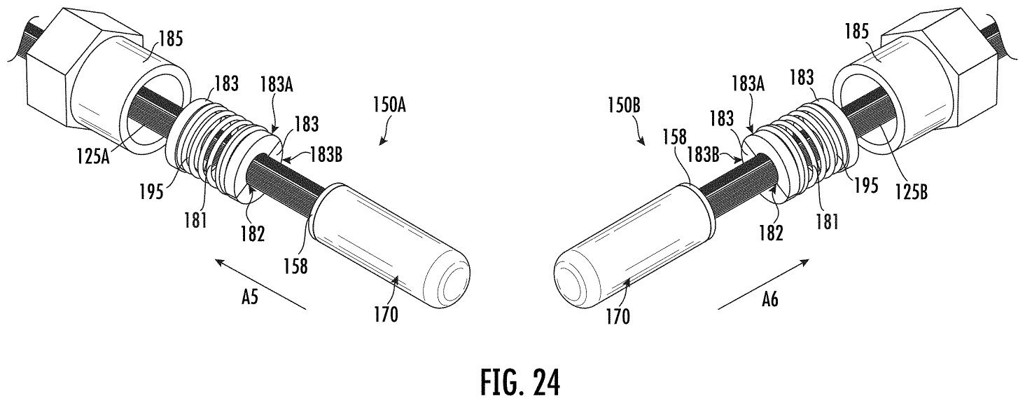

After this step, as shown in FIG. 24, connector nuts 185 are slid along directions A5, A6 to be further downstream of bushing 158, and spring sleeve 183 is installed over diced optical fibers 125A, 125B and are positioned such that spring 181 is positioned between spring sleeve 183. As shown, spring sleeve 183 comprises an upper half 183A and a lower half 183B that are coupled together to provide a surface 195 onto which spring 181 can be received and to provide an aperture 182 through which diced optical fibers 125A, 125B pass.

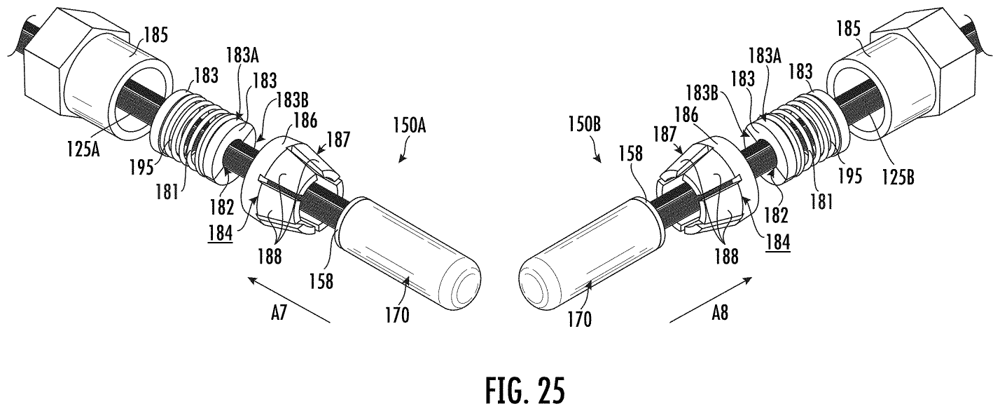

Referring now to FIG. 25, compression sleeve 187 is applied onto connectors 150A, 150B along directions A7, A8, respectively. Prior to application of compression sleeve 187 onto connectors 150A, 150B, spring 181 and spring sleeve 183 are slid further downstream of connectors 150A, 150B along directions A7, A8, respectively, to create space for compression sleeve 187. Similar to connector nut 185 and spring 181, compression sleeve 187 encircles diced optical fibers 125A, 125B by moving from in front of end faces 179A, 179B (encased by dust caps 170) along directions A7, A8 to a position adjacent to and downstream of bushing 158 as shown.

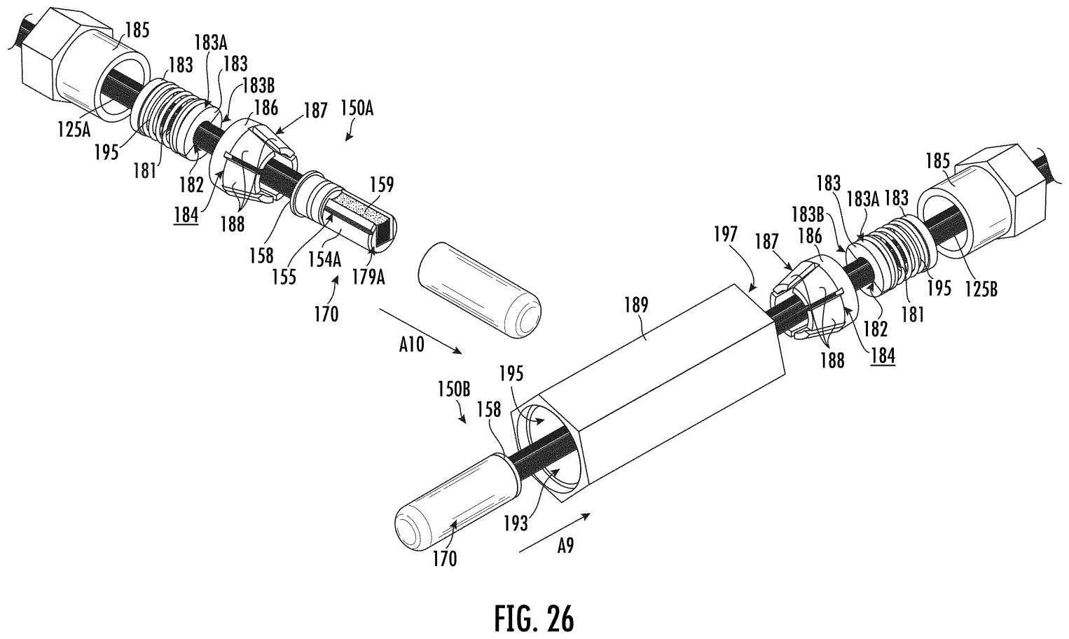

Referring now to FIG. 26, a center barrel 189 is installed onto connector 150B along direction A9. Prior to application of center barrel 189 onto connectors 150A, 150B, spring 181, spring sleeve 183, and compression sleeve 187 are slid further downstream of connectors 150A, 150B along direction A9 to create space for center barrel 189. Center barrel 189 encircle diced optical fibers 125A, 125B by moving from in front of end faces 179B (encased in dust cap 170) along direction A9 to a position adjacent to and downstream of bushing 158 as shown where dust cap 170 and connector 150B pass through inner channel 193 of center barrel 189.

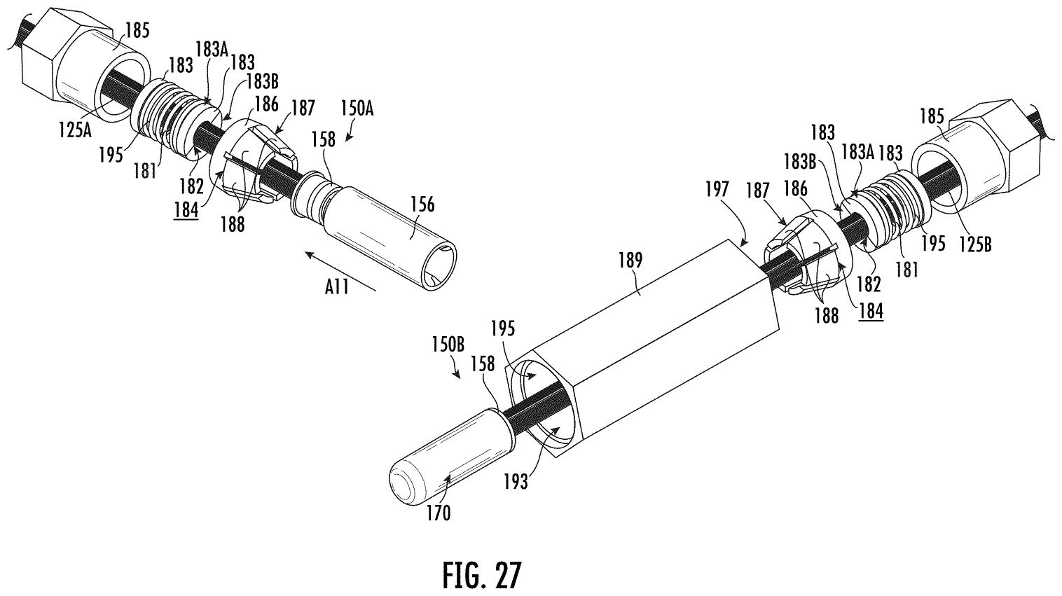

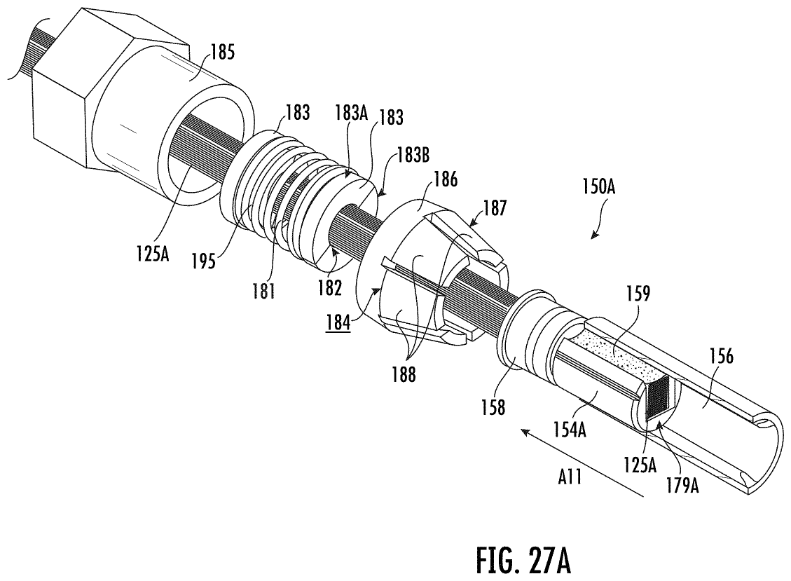

With continued reference to FIG. 26, a dust cap 170 is removed from connector 150A along direction A10. Then, and referring now to FIG. 27, sleeve 156 is applied onto connector 150A along direction A11. In particular, with reference to FIG. 27A, sleeve 156 (shown in partial cross section) and corresponding pins 160 and/or protrusions 175, as applicable, are applied onto ferrule 154 of connector 150A along direction A11 such that a portion of sleeve 156 and corresponding pins 160, as applicable, extend beyond end face 179A of connector 150A. As discussed above, various configurations of sleeve 154, pins 160, and ferrule 154 may be used.

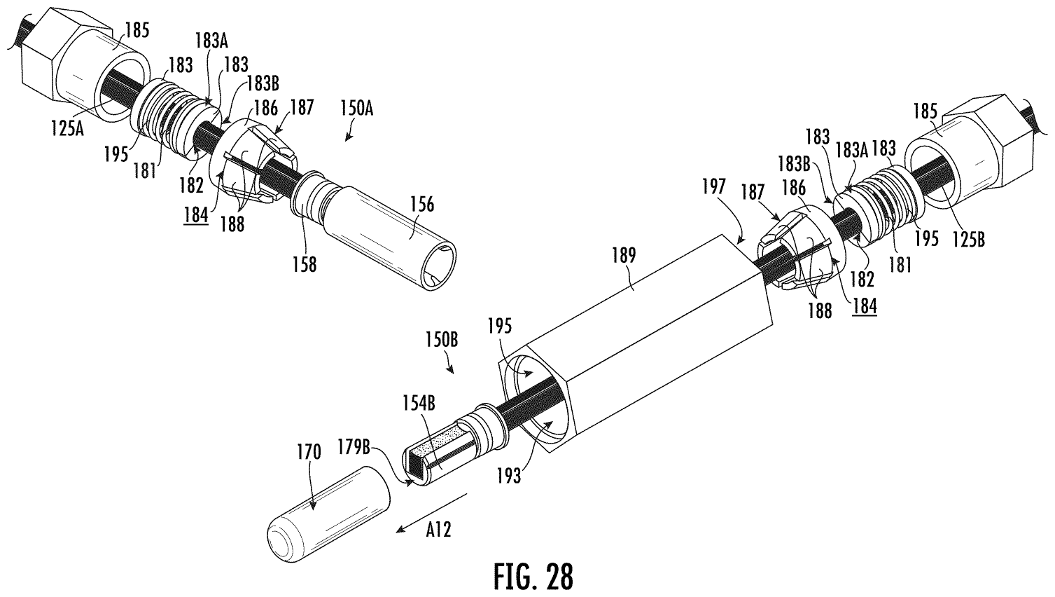

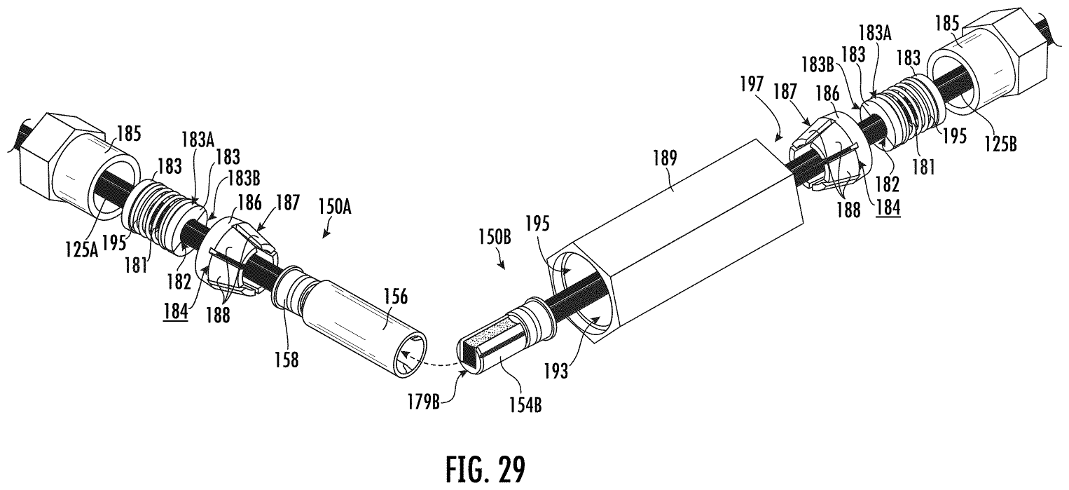

Then, as shown in FIG. 28, dust cap 170 is removed from connector 150B along direction A12. Referring now to FIG. 29, connector 150B is inserted into sleeve 156 and mated to connector 150A to form connector 152. In particular, connector 150B is inserted into an opening of sleeve 156 along the dashed line shown such that end faces 179A, 179B and connectors 150A, 150B are mated and ferrule 154, inner channel 153, and diced optical fibers 125A, 125B are aligned as shown in FIG. 5.

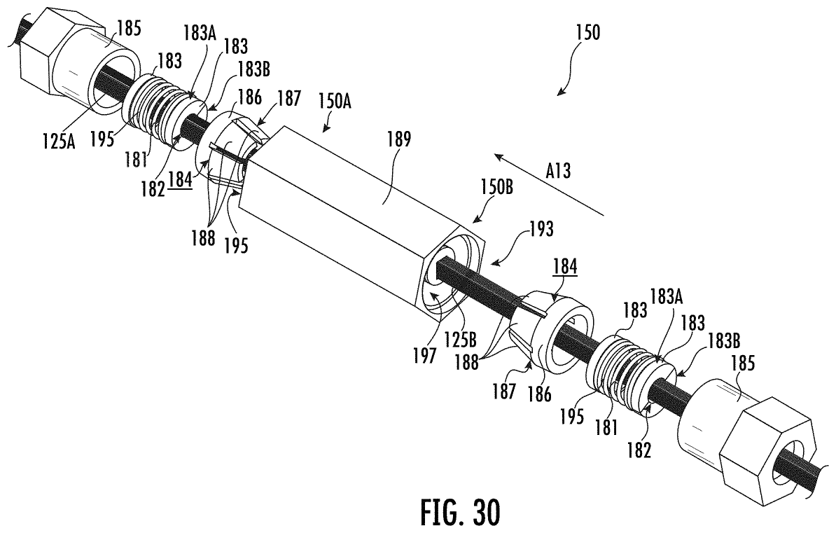

Referring now to FIG. 30, center barrel 189 is moved along direction A13 such that center barrel 189 has length L2 that spans a length of connector 152. Referring briefly back to FIG. 5, inward protrusion 190 is centered on mating interface 115 of connector 152 and provides a radial force onto connector 152 to maintain alignment of connector 152.

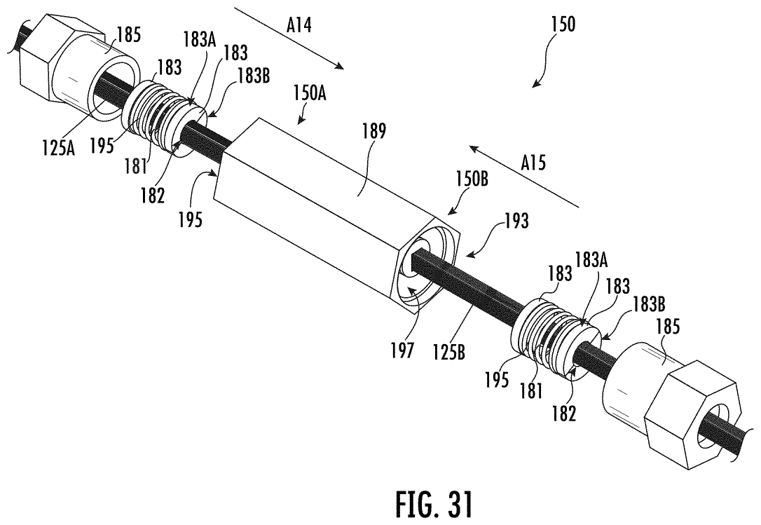

Then, with reference to FIG. 31, compression sleeves 187 are moved along directions A14 and A15 such that compression sleeves 187 are seated within inner channel 193 of center barrel 189 and adjacent to inward protrusion 190 of center barrel 189. As mentioned previously, compression sleeve 187 provides a securing force onto sleeve 156. In particular, when installed onto connector 152, compression sleeve 187 provides an axial force onto sleeve 156.

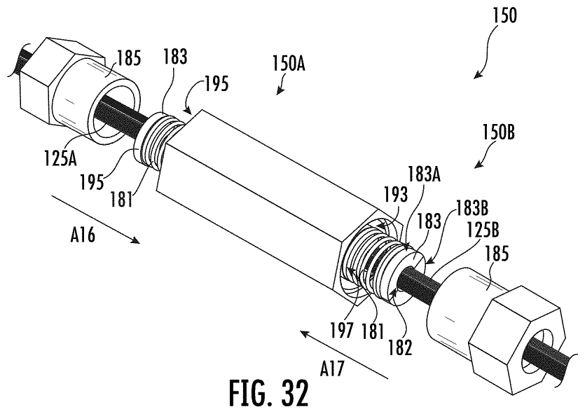

Referring now to FIG. 32, springs 181 and spring sleeves 183 are moved along respective optical fibers 125 in corresponding directions A16, A17 such that springs 181 and spring sleeves 183 are adjacent to bushings 158 of connector 152.

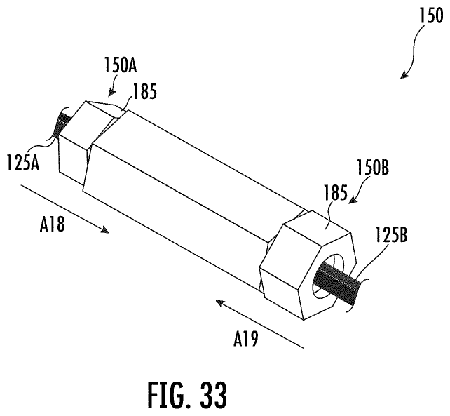

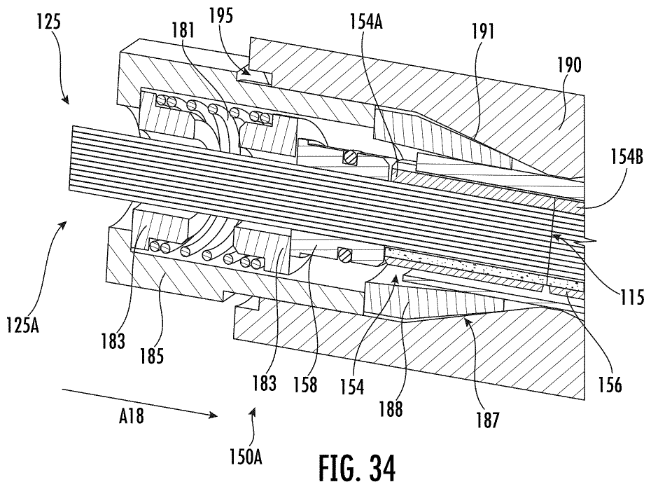

Then, with reference to FIG. 33, connector nuts 185 are moved along respective optical fibers 125A, 125B in corresponding directions A18, A19 such that connector nuts 185 engage with center barrel 189 as shown in FIG. 34 and discussed below. As shown in FIG. 34, when connector nut 185 moves along direction A18, connector nuts 185 are tightened onto or engages with walls of inner channel 193 of center barrel 189. In addition, the advancement of connector nut 185 into center barrel 189 compresses spring 181 by pushing on spring sleeve 183 in the direction of direction A18. The compression of spring 181 provides an axial force onto corresponding, adjacent bushing 158 and ferrule 154 of connectors 150A, 150B, which aids in maintaining the mating force on end faces 179 and axial alignment of diced optical fibers 125A, 125B of mated connectors 150A, 150B. Simultaneously, connector nut 185 pushes on compression sleeve 187 such that compression sleeve 187 contacts slanted edge 191 of inward protrusion 190 of center barrel 189. By contacting slanted edge 191, the axial force applied by teeth 188 of compression sleeve 187 as discussed previously is converted to a radial force that is applied onto sleeve 156 and ferrule 154 of mated connectors 150A, 150B thereby, ensuring coaxial alignment of mated connectors 150A, 150B. As mentioned previously, inward protrusion 190 directly contacts sleeve 156 to apply an additional radial force onto sleeve 156 and ferrule 154 to maintain coaxial alignment of mated connectors 150A, 150B.

An advantage of the above mentioned method is that assembly of connector assembly 150 can be completed mechanically by a technician without the use of specific tools while still creating the requisite interference fits and force distribution to provide proper sealing and maintain alignment of connector assembly 150. This simplifies the assembly process.

While the present disclosure above is directed to optical fibers 125 in accordance with the provided definition, it is within the scope of the present disclosure that connector assembly 150 may be used in alternate fiber optic applications in which optical fibers 125 comprise a fusion spliced optical fiber. In this embodiment, fusion splicing of optical fibers 125 is completed prior to installation within connector assembly 150 as discussed in U.S. Patent Application No. 63/225,606, filed Jul. 26, 2021, the disclosure of which is hereby incorporated by reference in its entirety.

Persons skilled in optical connectivity will appreciate additional variations and modifications of the elements disclosed herein. Such persons will also appreciate variations and modifications of the methods involving the elements disclosed herein. For example, although embodiments are described above where less than all of the bonding agent is melted and solidified when forming a fiber optic connector sub-assembly, in alternative embodiments all or substantially all of the bonding agent may be melted and solidified. In addition, skilled persons will appreciate alternatives where some of the steps described above are performed in different orders. To this end, where a method claim below does not actually recite an order to be followed by its steps or it is not otherwise specifically stated in the claims below or description above that the steps are to be limited to a specific order, it is no way intended that any particular order be inferred.

What is claimed is:

1. An optical fiber connector assembly comprising:
a plurality of optical fibers;
a connector including:
a ferrule having an inner channel in which the plurality of optical fibers are secured, the ferrule having at least one groove on an outer surface of the ferrule and along a length of the ferrule;
at least one stabilizing body received in the at least one groove; and
a sleeve applied onto the ferrule;
wherein the sleeve defines or engages the at least one stabilizing body and creates an interference fit between the ferrule and the sleeve.

2. The optical fiber connector assembly of claim 1, wherein the sleeve includes at least one protrusion integrally formed with the sleeve to define the at least one stabilizing body.

3. The optical fiber connector assembly of claim 2, wherein the sleeve spans a circumference of the ferrule.

4. The optical fiber connector assembly of claim 2, wherein a portion of the outer surface of the ferrule is in contact with the sleeve.

5. The optical fiber connector assembly of claim 1, wherein the ferrule includes at least one protrusion along the outer surface of the ferrule that engages with the sleeve.

6. The optical fiber connector assembly of claim 1, wherein the at least one stabilizing body comprises at least one pin received in the at least one groove, wherein the sleeve and engages the at least one pin and creates the interference fit.

7. The optical fiber connector assembly of claim 6, wherein the sleeve spans the outer surface of the ferrule.

8. The optical fiber connector assembly of claim 6, wherein a portion of the outer surface of the ferrule is in contact with the sleeve.

9. The optical fiber connector assembly of claim 1, wherein the ferrule includes at least one protrusion along the outer surface of the ferrule that engages with the sleeve.

10. The optical fiber connector assembly of claim 1, wherein the sleeve includes a slit extending along a length of the sleeve to create a gap, wherein the gap is aligned with at least a portion of the inner channel of the ferrule.

11. The optical fiber connector assembly of claim 1, wherein the sleeve includes a helical slit along a length of the sleeve.

12. An optical fiber connector assembly comprising:
a plurality of optical fibers;
a connector including:
a ferrule having an inner channel in which the plurality of optical fibers are secured, the ferrule having at least one groove on an outer surface of the ferrule and along a length of the ferrule;
at least one stabilizing body received in the at least one groove; and
a sleeve applied onto the ferrule, wherein the sleeve defines or engages the at least one stabilizing body and creates an interference fit between the ferrule and the sleeve;
a compression sleeve received over at least a portion of the sleeve, wherein the compression sleeve includes a plurality of teeth that contact the sleeve;
a center barrel having an inner channel that houses the connector, wherein the center barrel includes an inward protrusion that defines at least one slanted surface within the inner channel; and
a connector nut secured to the center barrel and urging compression sleeve against the at one slanted surface so that the plurality of teeth of the compression sleeve apply a radial force onto the connector.

13. The optical fiber connector assembly of claim 12, wherein the inward protrusion of center barrel contacts the connector.

14. The optical fiber connector assembly of claim 12, further comprising a spring retained within the connector nut and configured to bias the ferrule relative to the connector nut.

15. The optical fiber connector assembly of claim 14, further comprising a bushing between ferrule and spring, wherein biasing force from the spring is transferred to the ferrule by the bushing.

16. The optical fiber connector assembly of claim 15, wherein the spring is received on a spring sleeve that contacts the bushing to transfer the biasing force to the bushing.

17. The optical fiber connector assembly of claim 12, wherein the sleeve includes at least one protrusion integrally formed with the sleeve to define the at least one stabilizing body.

18. The optical fiber connector assembly of claim 17, wherein the sleeve spans a circumference of the ferrule.

19. The optical fiber connector assembly of claim 17, wherein a portion of the outer surface of the ferrule is in contact with the sleeve.

20. The optical fiber connector assembly of claim 12, wherein the ferrule includes at least one protrusion along the outer surface of the ferrule that engages with the sleeve.

21. The optical fiber connector assembly of claim 12, wherein the at least one stabilizing body comprises at least one pin received in the at least one groove, wherein the sleeve engages the at least one pin and creates the interference fit.

22. The optical fiber connector assembly of claim 21, wherein the sleeve spans the outer surface of the ferrule.

23. The optical fiber connector assembly of claim 21, wherein a portion of the outer surface of the ferrule is in contact with the sleeve.

24. The optical fiber connector assembly of claim 12, wherein the ferrule includes at least one protrusion along the outer surface of the ferrule that engages with the sleeve.

25. The optical fiber connector assembly of claim 12, wherein the sleeve includes a slit extending along a length of the sleeve to create a gap, wherein the gap is aligned with the inner channel of the ferrule.

26. The optical fiber connector assembly of claim 12, wherein the sleeve includes a helical slit along a length of the sleeve.

27. A method of assembling a connector assembly comprising:
inserting a plurality of optical fibers into an inner channel of a ferrule;
installing a bushing onto either side of the ferrule;
inserting an adhesive into the inner channel;
dicing the ferrule along a dicing plane to form a first connector ferrule and a second connector ferrule, wherein the dicing plane has an angle θ relative to a longitudinal axis of the ferrule;
applying a sleeve onto the first connector ferrule to form a first connector;
inserting the first connector into an inner channel of a center barrel, wherein at least the sleeve extends beyond an opening of the center barrel;
inserting the second connector ferrule into the sleeve to form a connector; and
moving the first connector ferrule, the second connector ferrule, and the sleeve into the inner channel.
